(19) United States
(12) Patent Application Publication
(10) Pub. No.: US 2008/0028458 A1
(43) Pub. Date: Jan. 31, 2008

(54) CLIENT SERVER DISTRIBUTED SYSTEM, CLIENT APPARATUS, SERVER APPARATUS, AND MUTUAL AUTHENTICATION METHOD USED THEREIN

(75) Inventors: Mao MASUHIRO, Tokyo (JP); Yasuhiro WATANABE, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION, Tokyo (JP)

(21) Appl. No.: 11/781,659

(22) Filed: Jul. 23, 2007

(30) Foreign Application Priority Data
Jul. 28, 2006 (JP) 2006-206688

(51) Int. Cl. G06F 7/04

(52) U.S. Cl. 726/14

(57) ABSTRACT

In a client-server distributed system including an SIP-protocol-coping server apparatus and an SIP-protocol-coping client apparatus, client authentication of the SIP-protocol-coping client apparatus is performed from the SIP-protocol-coping server apparatus by a client authentication unit. In the client-server distributed system, in addition to the client authentication, server authentication of the SIP-protocol-coping server apparatus is performed by a server authentication unit from the SIP-protocol-coping client apparatus. In the client-server distributed system, authentication completion is recognized when the bidirectional authentication is achieved.

This application is based upon and claims the benefit of priority from Japanese patent application No. 2006-206688, filed on Jul. 28, 2006, the disclosure of which is incorporated herein in its entirety by reference.

### BACKGROUND OF THE INVENTION

1. Field of the Invention

The present invention relates to a client-server distributed system, a client apparatus, a server apparatus, a mutual authentication method used therein, and a program therefor and, more particularly, to a mutual authentication method in a REGISTER (position information registration) state between a client and a server in a client-server distributed system coping with an SIP (Session Initiation Protocol) protocol.

2. Description of the Related Art

The SIP is defined as a protocol having a structure like an HTTP (Hyper Text Transfer Protocol) (for example, see “SIP: Session Initiation Protocol” [RFC (Request For Comments) 3261, June 2002]). In recent years, the SIP has been used as a general communication protocol. Since a connection method by the SIP is not directly related to the present invention, a description thereof will be omitted.

With respect to a detailed operation of a portion related to an HTTP-like authentication operation under session connection control in the SIP, HTTP authentication [basic authentication and Digest authentication] (for example, see “HTTP Authentication: Basic and Digest Access Authentication” (RFC2617, June 1999) is referred to. Registrations described in Chapter 10 of “SIP: Session Initiation Protocol” [RFC (Request For Comments) 3261, June 2002] are operations to manage affiliations of user agent clients. In section 3 of the explanation of a step in the operation, it is shown that a registered server should authenticate the user agent client.

In “SIP: Session Initiation Protocol” [RFC (Request For Comments) 3261, June 2002], an SIP server and a registered server are defined as different servers. However, as a matter of convenience for an apparatus, it must be considered that the SIP server and the registered server be logically present on the same hardware. With respect to client authentication by an HTTP authentication scheme, a mutual authentication scheme which exchanges information in section 6 “Authentication-Infor” and section 7 “Authorization” in a header field of Chapter 20 of “SIP: Session Initiation Protocol” [RFC (Request For Comments) 3261, June 2002] is referred to. In Chapter 22 of “SIP: Session Initiation Protocol” [RFC (Request For Comments) 3261, June 2002], a using method (“Usage of HTTP Authentication”) for the HTTP authentication is described.

These descriptions is about authentication in reception of a request in session control between an SIP server and a user client and a device which authenticates either the SIP server or the user client in reception of a request. The authentication is described as mutual authentication. Strictly, at the same time, an SIP server and a user client connected thereto do not perform mutual authentication operation. Therefore, spoof prevention when a malicious SIP server spoofs to be present on the same domain as that of a registered server and a regular SIP server is not assumed.

Since an SIP-protocol-coping client-server distributed system is a system connected on a LAN (Local Area Network), security must be assured. As a measure for securing security, an authentication scheme is defined in “SIP: Session Initiation Protocol” [RFC (Request For Comments) 3261, June 2002]. This authentication scheme is a Digest authentication (to be referred to as client authentication hereinafter) scheme which authenticates an SIP-protocol-coping client apparatus by a Challenge Response scheme using a user name and a password of the SIP-protocol-coping client apparatus.

Rough authentication procedures of the Challenge Response scheme are as follows:

1) a server which performs authentication generates a random number;

2) the server transmits the generated random value to a client to be authenticated (Challenge);

3) a client calculates the random value received from the server and a value (secret key) such as a password shared by the server and the client in combination with each other and transmits the calculation result (Digest) to the server (Response); and

4) the server regards that a destination knows the secret key when the calculation result of the client is equal to a locally calculated value to set authentication achievement.

Related arts referring to “SIP: Session Initiation Protocol” [RFC (Request For Comments) 3261, June 2002] and “HTTP Authentication: Basic and Digest Access Authentication” (RFC2617, June 1999) will be described below with reference to FIGS. 31 and 32. In the following description, a client authentication scheme in an SIP-protocol-coping client-server distributed system will be described below. FIG. 31 is a block diagram showing a configuration of a server apparatus and a client apparatus constituting a client-server distributed system of the client authentication scheme according to the related arts. FIG. 32 is a sequence chart showing an operation of a client authentication scheme according to the related example.

As shown in FIG. 31, in the related SIP-protocol-coping client-server distributed system, an SIP-protocol-coping server apparatus (to be referred to as a server apparatus hereinafter) 6 and SIP-protocol-coping client apparatuses (to be referred to as client apparatuses hereinafter) 8-1 to 8-3 are connected to each other through an internet/intranet/LAN (to be referred to as only a LAN hereinafter) 100. In FIG. 31, the configuration of only the client apparatus 8-1 is shown. Each of the other client apparatuses 8-2 and 8-3 has the same configuration as that of the client apparatus 8-1.

The server apparatus 6 includes at least a user name/password setting unit 11, a user name/password input interface unit 12, an SIP interface unit 13, a client authentication unit 14, an SIP message forming unit 16 and an SIP message analyzing unit 17. A local maintenance console 7 is connected to the server apparatus 6 with a serial interface or the like. The local maintenance console 7 of the server apparatus 6 is temporarily installed in a construction period or the like of the server apparatus 6. The local maintenance console 7 need not be connected to the server apparatus 6 during the operation.

Each of the client apparatuses 8-1 to 8-3 includes at least a user name/password setting unit 31, a user name/password input interface unit 81, an SIP interface unit 33, a client authentication unit 34, an SIP message forming unit 36, and an SIP message analyzing unit 37. A local maintenance console 9 is connected to each of the client apparatuses 8-1 to 8-3 with a serial interface or the like. The local maintenance console 9 of each of the client apparatuses 8-1 to 8-3 is temporarily installed during a construction period or the like of corresponding one of the client apparatuses 8-1 to 8-3. The local maintenance console 9 need not be connected during the operation.

An operation of a client authentication scheme in the related SIP-protocol-coping client-server distributed system will be described below with reference to FIG. 32. In FIG. 32, the operation of the client apparatus 8-1 is shown. The client apparatuses 8-2 and 8-3 perform the same operation as that of the client apparatus 8-1.

When the user name and the password of the client apparatus 8-1 is input in advance from the local maintenance console 7 connected to the server apparatus 6 (r11 in FIG. 32), the user name/password input interface unit 12 receives a set request including the user name/password data (r12 in FIG. 32). When the normality of the user name and the password can be confirmed, the user name/password input interface unit 12 communicates the user name and the password to the user name/password setting unit 11. The user name/password setting unit 11 stores the user name and the password (r21 in FIG. 32) and transmits setting completion from the user name/password input interface unit 12 to the local maintenance console 7 (r22 in FIG. 32).

When the user name and the password of the client apparatus 8-1 is input in advance from the local maintenance console 9 connected to the client apparatus 8-1 (r41 in FIG. 32), the user name/password input interface unit 81 receives a set request including the user name/password data (r42 in FIG. 32). When the normality of the user name and the password can be confirmed, the client apparatus 8-1 communicates the user name and the password to the user name/password setting unit 31. The user name/password setting unit 31 stores the user name and the password (r31 in FIG. 32) and transmits setting completion from the user name/password input interface unit 81 to the local maintenance console 9 (r32 in FIG. 32). In this case, the user names and the passwords input to the server apparatus 6 and the client apparatus 8-1 are values shared (the same values) shared by both the server apparatus 6 and the client apparatus 8-1.

When the client apparatus 8-1 is incorporated in the SIP-protocol-coping client-server distributed system including the server apparatus 6 and operated, after the user name and the password are set in the user name/password setting unit 31, the client apparatus 8-1 is started(r33 in FIG. 32). In this case, the client authentication unit 34 designates the SIP message forming unit 36 to form a REGISTER message. In this case, the REGISTER message is a message used when the client apparatus 8-1 registers present position information in the server apparatus 6.

The SIP message forming unit 36 transfers the REGISTER message to the SIP interface unit 33, and the SIP interface unit 33 transmits the REGISTER message to the SIP interface unit 13 of the server apparatus 6 through the LAN 100 (r34 in FIG. 32).

The SIP interface unit 13 of the server apparatus 6 which receives the REGISTER message confirms the normality of a format or the like of the REGISTER message. When the REGISTER message is normal, the REGISTER message is transferred to the SIP message analyzing unit 17. When the received message is the REGISTER message, the SIP message analyzing unit 17 designates the client authentication unit 14 to start authentication of the client apparatus 8-1.

The client authentication unit 14 designated to start authentication of the client apparatus 8-1 designates the SIP message forming unit 16 to form a 401 response message (401 Unauthorized) added with Challenge and stores the Challenge data.

The SIP message forming unit 16 forms a 401 response message added with the Challenge, and transfers the formed 401 response message to the SIP interface unit 13. The SIP interface unit 13 transmits the 401 response message to the SIP interface unit 33 of the client apparatus 8-1 through the LAN 100 (r23 in FIG. 32).

The SIP interface unit 33 of the client apparatus 8-1 which receives the 401 response message added with the Challenge confirms normality of a format or the like of the 401 response message. When the 401 response message is normal, the SIP interface unit 33 transfers the 401 response message to the SIP message analyzing unit 37. When the received message is the 401 response message added with the Challenge, the SIP message analyzing unit 37 notifies the client authentication unit 34 of the Challenge.

The client authentication unit 34 which receives notification of the Challenge designates the SIP message forming unit 36 to form a REGISTER message added with the Digest. The SIP message forming unit 36 transfers the formed REGISTER message to the SIP interface unit 33. The SIP interface unit 33 transmits the REGISTER message to the SIP interface unit 13 of the server apparatus 6 through the LAN 100 (r35 in FIG. 32).

The SIP interface unit 13 which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (r24 in FIG. 32). When the authentication is achieved, authentication of the client apparatus 8-1 is completed. The client authentication unit 14 designates the SIP message forming unit 16 to form a 200 response message (200 OK). The SIP message forming unit 16 transfers the formed 200 response message to the SIP interface unit 13. The SIP interface unit 13 transfers the 200 response message to the SIP interface unit 33 of the client apparatus 8-1 through the LAN 100 (r25 in FIG. 32).

The SIP interface unit 33 of the client apparatus 8-1 which receives the 200 response message confirms the normality of a format or the like of the 200 response message. When the 200 response message is normal, the SIP interface unit 33 transfers the 200 response message to the SIP message analyzing unit 37. When the message is the 200 response message, the SIP message analyzing unit 37 notifies the client authentication unit 34 of client authentication achievement response reception. When the client authentication unit 34 recognizes client authentication achievement in response to the client authentication response reception notification (r26 in FIG. 32).

In the above configuration and the flow, when the client authentication from the server apparatus 6 to the client apparatus 8-1 is achieved and completed, a system operation can be performed. Subsequently, communication and a call processing can be performed. The Challenge is a value calculated by item 2) of the authentication procedures of a Challenge-Response scheme in the server apparatus 6, and the Response is a value calculated by item 3) of the authentication procedures of the Challenge-Response scheme in the client apparatus 8-1.

As the SIP-protocol-coping client-server distributed system, a technique which structures a secure data channel between clients by using the authentication between a server and a client is also proposed (for example, see JP-A-2005-229436).

In the related SIP-protocol-coping client-server distributed system described above, in client authentication, when client authentication of an SIP-protocol-coping client apparatus is achieved by an SIP-protocol-coping server apparatus, and an operation in the SIP-protocol-coping client-server distributed system can be performed, and communication and call processing between the SIP-protocol-coping client and the SIP-protocol-coping server can be performed. For this reason, when another SIP-protocol-coping server apparatus having the same interface function as that of the SIP-protocol-coping server apparatus is connected onto an internet/intranet/LAN, the SIP-protocol-coping client apparatus may be connected to an erroneous SIP-protocol-coping server apparatus disadvantageously.

In the related SIP-protocol-coping client-server distributed system, when the malicious third party connects another SIP-protocol-coping serving apparatus having the same interface function as that of the SIP-protocol-coping server apparatus onto the internet/intranet/LAN to spoof an SIP-protocol-coping server apparatus, the SIP-protocol-coping client apparatus may be connected to an erroneous SIP-protocol-coping server apparatus. Harm caused by spoofing or the like of the SIP-protocol-coping server apparatus cannot be prevented.

Therefore, in the related SIP-protocol-coping client-server distributed system, in client authentication, spoofing of an SIP-protocol-coping client apparatus can be prevented. However, spoofing of an SIP-protocol-coping server apparatus cannot be prevented, and advanced security cannot be easily assured.

The related SIP-protocol-coping client-server distributed system may be disadvantageously attacked by hacking or the like because SIP-protocol-coping client-server communication performed by the same authentication result for a long period of time is continuously enabled in client authentication.

Furthermore, in the related SIP-protocol-coping client-server distributed system, in client authentication, when client-server communication is temporarily interrupted, the client apparatus is disconnected from the system to disable the communication, and the system cannot be restored. In this case, in a related SIP-protocol-coping client-server distributed system, when the client-server communication is temporarily interrupted, if authentication to the client is kept valid, spoofing of the client apparatus by the third party may not be able to be prevented.

Furthermore, in the related SIP-protocol-coping client-server distributed system, in client authentication, when a password to be used in the authentication is input from an external maintenance interface, a certain number of steps to manually input and manage authentication data are disadvantageously required, and the password can be relatively easily presumed. These problems become conspicuous when the scale of the system increases. In this case, in the related SIP-protocol-coping client-server distributed system, since the authentication data is manually input, the authentication data may disadvantageously flow out regardless of the presence/absence of malicious intent of a holder.

### SUMMARY OF THE INVENTION

Therefore, it is an object of the present invention to provide a client-server distributed system which can solve the above problems and can reinforce the security against spoofing of an SIP-protocol-coping server apparatus, a client apparatus, a server apparatus, a mutual authentication method used therein, and a program.

In a client-server distributed system according to the present invention which is constituted by connecting an SIP (Session Initiation Protocol)-protocol-coping client apparatus and an SIP-protocol-coping server apparatus to a network, client authentication to authenticate the client apparatus being performed from the server apparatus when the client apparatus registers position information in the server apparatus,

means to authenticate the server apparatus from the client apparatus is arranged in each of the server apparatus and the client apparatus.

The client apparatus according to the present invention includes the means described in the client-server distributed system.

The server apparatus according to the present invention includes the means described in the client-server distributed system.

In a mutual authentication method according to the present invention used in an SIP (Session Initiation Protocol)-protocol-coping client-server distributed system which is constituted by connecting an SIP-protocol-coping client apparatus and an SIP-protocol-coping server apparatus to a network, client authentication to authenticate the client apparatus being performed from the server apparatus when the client apparatus registers position information in the server apparatus,

each of the server apparatus and the client apparatus executes a process to authenticate the server apparatus from the client apparatus.

In a program according to the present invention executed by a client apparatus in an SIP (Session Initiation Protocol)-protocol-coping client-server distributed system which is constituted by connecting an SIP-protocol-coping client apparatus and an SIP-protocol-coping server apparatus to a network, client authentication to authenticate the client apparatus being performed from the server apparatus when the client apparatus registers position information in the server apparatus,

a process of setting and storing an externally input server name of the server apparatus and a user name and a password of the client apparatus and a process of authenticating a server name and a password of a server apparatus to be connected are caused to be executed by a central processing device of the client apparatus, and authentication of the server apparatus is performed from the client apparatus.

More specifically, according to the present invention, in the SIP (Session Initiation Protocol)-protocol-coping client-server distributed system connected to a network [for example, the internet, an intranet, a LAN (Local Area Network), or the like], a maintenance interface connected to the server apparatus by the LAN or a serial interface when Digest authentication (to be referred to as client authentication) (see “SIP: Session Initiation Protocol” [RFC (Request For Comments) 3261, June 2002]) is performed from an SIP-protocol-coping server apparatus (to be referred to as a server apparatus hereinafter) to an SIP-protocol-coping client apparatus (to be referred to as a client apparatus hereinafter), means which inputs and sets a user name and a password of the client apparatus input through the maintenance interface, means which authenticates the user name and the password of the connected client apparatus, and means which communicates with the client apparatus by using the SIP protocol are arranged.

In the client-server distributed system according to the present invention, the client apparatus includes a maintenance interface represented by a Telnet interface or a serial interface, means which sets the server name of the server apparatus and the user name and the password of the client apparatus input from the maintenance interface, means which authenticates the server name and the password of the connected server apparatus in user of the client apparatus, and means which communicates with the server apparatus by using the SIP protocol.

For this reason, in the client-server distributed system according to the present invention, in the above configuration, when authentication (to be referred to as server authentication hereinafter) of the server apparatus is performed by the client apparatus, security against spoofing of the server apparatus can be reinforced. In this case, by using the procedures (the authenticating procedure of the Challenge-Response scheme) in the client authentication, the server authentication is performed such that a procedure of the server apparatus is executed by the client apparatus, and a procedure of the client apparatus is executed by the server apparatus.

In the client-server distributed system according to the present invention, in the above configuration, the client authentication and the server authentication between the client apparatus and the server apparatus are periodically executed to make it possible to reduce the chances of deteriorating security by continuously enabling communication between the client apparatus and the server apparatus for a long period of time.

Furthermore, in the client-server distributed system according to the present invention, in the above configuration, the client authentication and the server authentication are reexecuted when the communication between the client apparatus and the server apparatus is interrupted for a predetermined period of time to perform smooth system restoration and to make it possible to minimize the chances of lowering security.

Still furthermore, in the client-server distributed system according to the present invention, in the above configuration, the client authentication and the server authentication between the client apparatus and the server apparatus are executed by using a one-time password input from an external maintenance interface in only an initial start-up state of the client apparatus, and security of a password can be improved by using a mutual authentication password automatically generated and notified from the authenticated server apparatus in the second and subsequent start-up state.

The present invention uses the above configurations and operations to obtain an advantage of being capable of reinforcing security against spoofing of an SIP-protocol-coping server apparatus.

### BRIEF DESCRIPTION OF THE DRAWINGS

FIG. 1 is a block diagram showing a configuration of an SIP-protocol-coping client-server distributed system according to a first embodiment of the present invention;

FIG. 2 is a sequence chart showing an operation of the client-server distributed system according to the first embodiment of the present invention;

FIG. 3 is a sequence chart showing an operation of an SIP-protocol-coping client-server distributed system according to a second embodiment of the present invention;

FIG. 4 is a block diagram showing a configuration of an SIP-protocol-coping client-server distributed system according to a third embodiment of the present invention;

FIG. 5 is a sequence chart showing an operation of the SIP-protocol-coping client-server distributed system according to the third embodiment of the present invention;

FIG. 6 is a sequence chart showing an operation of an SIP-protocol-coping client-server distributed system according to a fourth embodiment of the present invention;

FIG. 7 is a sequence chart showing an operation of an SIP-protocol-coping client-server distributed system according to a fifth embodiment of the present invention;

FIG. 8 is a block diagram showing a configuration of an SIP-protocol-coping client-server distributed system according to a sixth embodiment of the present invention;

FIG. 9 is a sequence chart showing an operation of the SIP-protocol-coping client-server distributed system according to the sixth embodiment of the present invention;

FIG. 10 is a block diagram showing a configuration of an SIP-protocol-coping client-server distributed system according to a seventh embodiment of the present invention;

FIG. 11 is a sequence chart showing an operation of the SIP-protocol-coping client-server distributed system according to the seventh embodiment of the present invention;

FIG. 12 is a block diagram showing a configuration of an SIP-protocol-coping client-server distributed system according to an eighth embodiment of the present invention;

FIG. 13 is a sequence chart showing an operation of the SIP-protocol-coping client-server distributed system according to the eighth embodiment of the present invention;

FIG. 14 is a sequence chart showing an operation of the SIP-protocol-coping client-server distributed system according to the eighth embodiment of the present invention;

FIG. 15 is a block diagram showing a configuration of an SIP-protocol-coping client-server distributed system according to a ninth embodiment of the present invention;

FIG. 16 is a sequence chart showing an operation of the SIP-protocol-coping client-server distributed system according to the ninth embodiment of the present invention;

FIG. 17 is a sequence chart showing an operation of the SIP-protocol-coping client-server distributed system according to the ninth embodiment of the present invention;

FIG. 18 is a sequence chart showing an operation of an SIP-protocol-coping client-server distributed system according to a tenth embodiment of the present invention;

FIG. 19 is a sequence chart showing an operation of the SIP-protocol-coping client-server distributed system according to the tenth embodiment of the present invention;

FIG. 20 is a sequence chart showing an operation of an SIP-protocol-coping client-server distributed system according to an eleventh embodiment of the present invention;

FIG. 21 is a sequence chart showing an operation of the SIP-protocol-coping client-server distributed system according to the eleventh embodiment of the present invention;

FIG. 22 is a block diagram showing a configuration of an SIP-protocol-coping client-server distributed system according to a thirteenth embodiment of the present invention;

FIG. 23 is a sequence chart showing an operation of the SIP-protocol-coping client-server distributed system according to the thirteenth embodiment of the present invention;

FIG. 24 is a sequence chart showing an operation of the SIP-protocol-coping client-server distributed system according to the thirteenth embodiment of the present invention;

FIG. 25 is a sequence chart showing an operation of an SIP-protocol-coping client-server distributed system according to a fourteenth embodiment of the present invention;

FIG. 26 is a sequence chart showing an operation of the SIP-protocol-coping client-server distributed system according to the fourteenth embodiment of the present invention;

FIG. 27 is a block diagram showing a configuration of an SIP-protocol-coping client-server distributed system according to a fifteenth embodiment of the present invention;

FIG. 28 is a sequence chart showing an operation of the SIP-protocol-coping client-server distributed system according to the fifteenth embodiment of the present invention;

FIG. 29 is a diagram for explaining an advantage of the present invention;

FIG. 30 is a diagram for explaining another advantage of the present invention;

FIG. 31 is a block diagram showing a system configuration of a related maintenance interface user authentication scheme; and

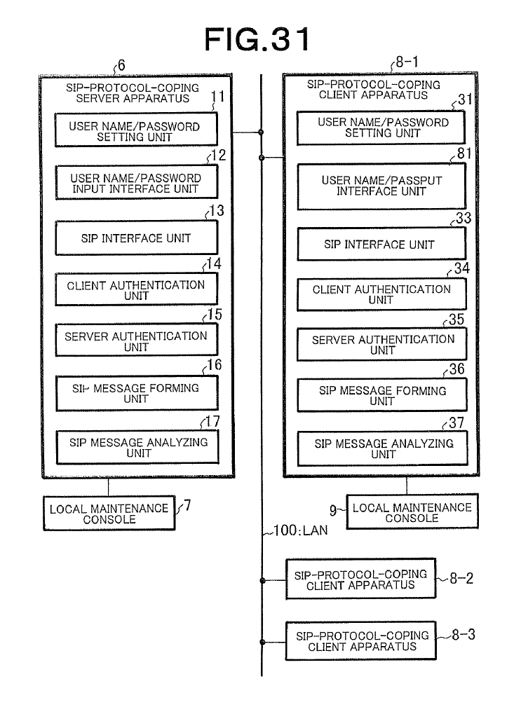

FIG. 32 is a sequence chart showing an operation of the system shown in FIG. 31.

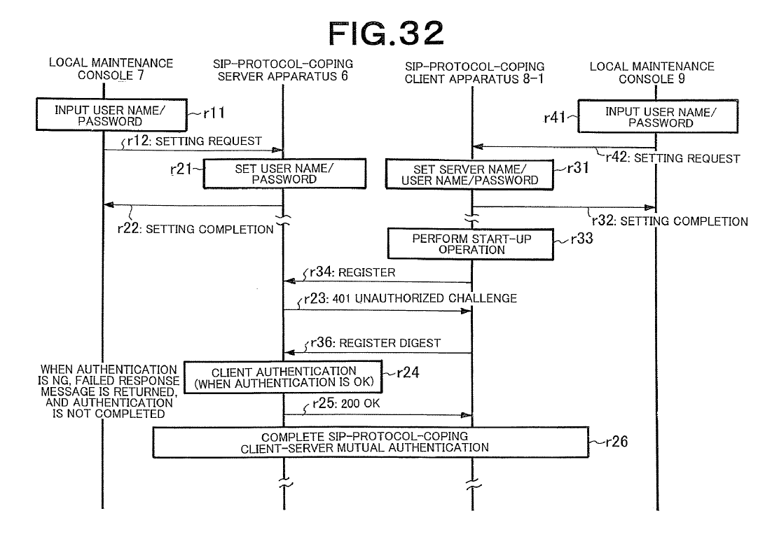

### DESCRIPTION OF THE PREFERRED EMBODIMENTS

Next, embodiments of the present invention will be described hereinafter with reference to the accompanying drawings.

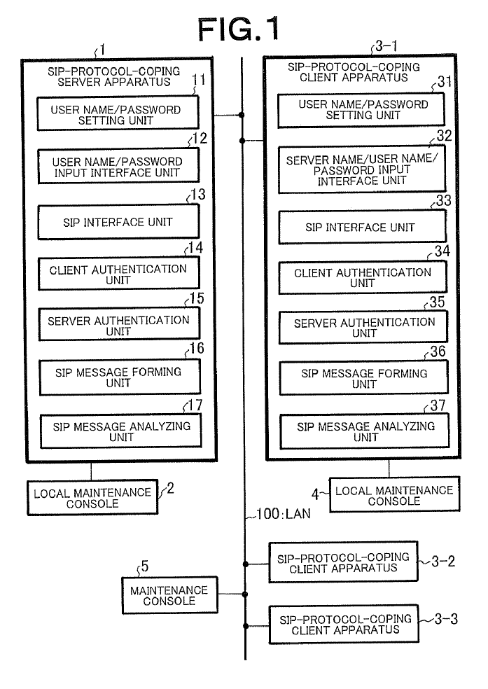

FIG. 1 is a block diagram showing a configuration of an SIP (Session Initiation Protocol)-protocol-coping client-server distributed system according to a first embodiment of the present invention. In FIG. 1, the client-server distributed system according to the first embodiment of the present invention includes an SIP-protocol-coping server apparatus (to be referred to as a server apparatus hereinafter) 1, local maintenance consoles 2 and 4, SIP-protocol-coping client apparatuses (to be referred to as client apparatuses hereinafter) 3-1 to 3-3, and a maintenance console 5. The SIP-protocol-coping client apparatuses 3-1 to 3-3 and the maintenance console 5 are connected to each other by a LAN (Local Area Network) 100.

The server apparatus 1 includes at least a user name/password setting unit 11, a user name/password input interface unit 12, an SIP interface unit 13, a client authentication unit 14, a server authentication unit 15, an SIP message forming unit 16, and an SIP message analyzing unit 17. The local maintenance console 2 is connected to the SIP-protocol-coping server apparatus 1 by a serial cable or the like. The local maintenance console 2 is to be temporarily installed in a construction period or the like of the server apparatus 1, and need not be connected to the server apparatus 1 during an operation of the server apparatus 1.

In the server apparatus 1, the user name/password setting unit 11, the user name/password input interface unit 12, the SIP interface unit 13, the client authentication unit 14, the server authentication unit 15, the SIP message forming unit 16, and the SIP message analyzing unit 17 can be realized by executing a program by a CPU (Central Processing Unit) (not shown).

The client apparatus 3-1 includes at least the user name/password setting unit 31, a server name/user name/password input interface unit 32, the SIP interface unit 33, the client authentication unit 34, a server authentication unit 35, the SIP message forming unit 36, and the SIP message analyzing unit 37. The local maintenance console 4 is connected to the client apparatus 3-1 by a serial cable or the like. The local maintenance console 4 is to be temporarily installed in the construction period of the client apparatus 3-1, and need not be connected during the operation of the client apparatus 3-1.

In the client apparatus 3-1, the user name/password setting unit 31, the server name/user name/password input interface unit 32, the SIP interface unit 33, the client authentication unit 34, the server authentication unit 35, the SIP message forming unit 36, and the SIP message analyzing unit 37 can be realized by executing a program by a CPU (not shown). Furthermore, the client apparatuses 3-2 and 3-3 have the same configuration as that of the client apparatus 3-1.

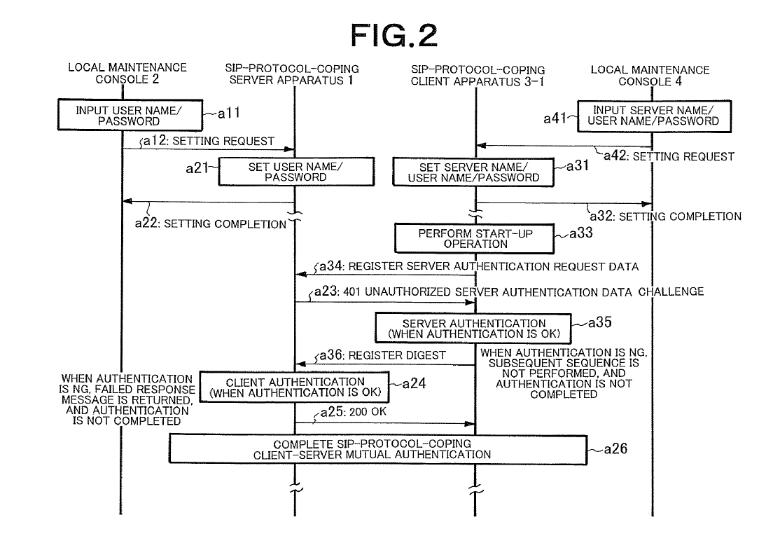

In the embodiment, the configuration described above is realized, the client apparatus 3-1 is authenticated from the server apparatus 1, and the server apparatus 1 is authenticated from the client apparatus 3-1. FIG. 2 is a sequence chart showing an operation of the client-server distributed system according to the first embodiment of the present invention. The operation of the client-server distributed system according to the first embodiment of the present invention will be described below with reference to FIGS. 1 and 2. Processes of the server apparatus 1 shown in FIG. 2 and processes of the client apparatus 3-1 are realized such that programs are executed by the CPUs in the server apparatus 1 and the client apparatus 3-1.

When a user name and a password of the client apparatus 3-1 are input from the local maintenance console 2 connected to the server apparatus 1 in advance (a11 in FIG. 2), the user name/password input interface unit 12 receives a setting request including the user name/password data (a12 in FIG. 2). When the normality of the user name and the password can be confirmed, the user name/password input interface unit 12 communicates the user name and the password to the user name/password setting unit 11. The user name/password setting unit 11 stores the user name and the password (a21 in FIG. 2), and setting completion is transmitted from the user name/password input interface unit 12 to the local maintenance console 2 (a22 in FIG. 2).

When a server name of the server apparatus 1 and a user name and a password of the client apparatus 3-1 are input from the local maintenance console 4 connected to the client apparatus 3-1 in advance (a41 in FIG. 2), the server name/user name/password input interface unit 32 receives a setting request including the server name/user name/password data (a42 in FIG. 2). When the normality of the server name, the user name, and the password can be confirmed, the server name/user name/password input interface unit 32 communicates the server name, the user name, and the password to the user name/password setting unit 31. The user name/password setting unit 31 stores the server name, the user name, and the password (a31 in FIG. 2), and setting completion is transmitted from the server name/user name/password input interface unit 32 to the local maintenance console 4 (a32 in FIG. 2). In this case, the user name and the password input to the server apparatus 1 and the client apparatus 3-1 are values (same values) shared by the server apparatus 1 and the client apparatus 3-1.

After the server name, the user name, and the password are set in the user name/password setting unit 31, when the client apparatus 3-1 is started up (a33 in FIG. 2), the server authentication unit 35 designates the SIP message forming unit 36 to form a REGISTER message added with authentication request data (to be referred to as server authentication request data hereinafter) for authentication (to be referred to as server authentication hereinafter) from the client apparatus 3-1 to the server apparatus 1, and stores the server authentication request data. In this case, the REGISTER message is a message to cause the client apparatus 3-1 to register present position information in the server apparatus 1.

The SIP message forming unit 36 transfers the formed REGISTER message to the SIP interface unit 33. The SIP interface unit 33 transmits the REGISTER message to the SIP interface unit 13 of the server apparatus 1 through the LAN 100 (a34 in FIG. 2).

The SIP interface unit 13 of the server apparatus 1 which receives the REGISTER message added with the server authentication request data confirms the normality of a format or the like of the REGISTER message. When the REGISTER message is normal, the SIP interface unit 13 transfers the REGISTER message to the SIP message analyzing unit 17. When the received message is the REGISTER message added with the server authentication request data, the SIP message analyzing unit 17 designates the client authentication unit 14 to start authentication of the client apparatus 3-1 and notifies the server authentication unit 15 of the server authentication request data.

The client authentication unit 14 designated to start the authentication of the client apparatus 3-1 designates the SIP message forming unit 16 to form a 401 response message added with Challenge and stores the Challenge data. In this case, the Challenge data denotes a random value generated by the authentication procedure of the Challenge-Response scheme.

At the same time, the server authentication unit 15 designates the SIP message forming unit 16 to form 401 response message (401 Unauthorized) added with authentication data for server authentication. The SIP message forming unit 16 forms the 401 response messages added with the Challenge and the server authentication data and transfers the formed 401 response messages to the SIP interface unit 13. The SIP interface unit 13 transmits the 401 response messages to the SIP interface unit 33 of the client apparatus 3-1 through the LAN 100 (a23 in FIG. 2).

The SIP interface unit 33 of the client apparatus 3-1 which receives the 401 response messages added with the Challenge and the server authentication data recognizes the normality of a format or the like of the 401 response message. When the 401 response message is normal, the SIP interface unit 33 transfers the 401 response messages to the SIP message analyzing unit 37. When the received messages are the 401 response messages added with the Challenge and the server authentication data, the SIP message analyzing unit 37 notifies the client authentication unit 34 of the Challenge data and notifies the server authentication unit 35 of the server authentication data.

The server authentication unit 35 authentication of the received server authentication data by using the server name, user name, and the password set in the user name/password setting unit 31 (server authentication) (a35 in FIG. 2). When the authentication is achieved, the server authentication unit 35 notifies the client authentication unit 34 of server authentication achievement. The client authentication unit 34 which receives the notification of the server authentication achievement and the notification of the challenge data recognizes the server authentication achievement and designates the SIP message forming unit 36 to form a REGISTER message added with Digest.

The SIP message forming unit 36 forms the REGISTER message added with the Digest and transfers the formed REGISTER message to the SIP interface unit 33. The SIP interface unit 33 transmits the REGISTER message to the SIP interface unit 13 of the server apparatus 1 through the LAN 100 (a36 in FIG. 2). In this case, the Digest is a value calculated by combining a received random value (Challenge data) and a value (secret key) of a password or the like shared by both the client apparatus and the server apparatus in the authentication procedure of the Challenge-Response scheme.

The SIP interface unit 13 of the server apparatus 1 which receives the REGISTER message added with the Digest confirms the normality of the format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (a24 in FIG. 2). When the Digest is authenticated, the client authentication unit 14 completes the authentication of the client apparatus 3-1 and designates the SIP message forming unit 16 to form a 200 response message (200 OK). The SIP message forming unit 16 transfers the formed 200 response message to the SIP interface unit 13. The SIP interface unit 13 transmits the 200 response message to the SIP interface unit 33 of the client apparatus 3-1 through the LAN 100 (a25 in FIG. 2).

The SIP interface unit 33 of the client apparatus 3-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception. The client authentication unit 34 recognizes client authentication achievement in response to the client authentication achievement response reception notification (a26 in FIG. 2).

Therefore, since the client apparatus 3-1 does not complete the authentication until the server authentication of the corresponding server apparatus 1 is achieved, security in the SIP-protocol-coping client-server distributed system can be reinforced.

### Second Embodiment

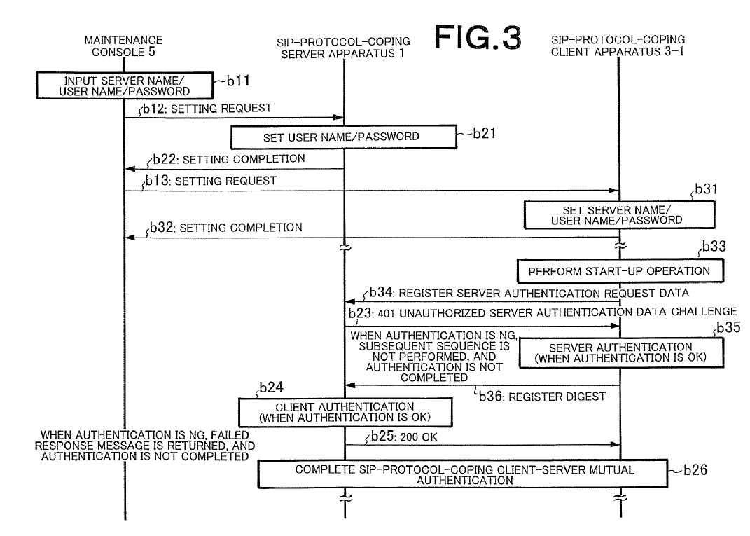

FIG. 3 is a sequence chart showing an operation of an SIP-protocol-coping client-server distributed system according to a second embodiment of the present invention. Since the client-server distributed system according to the second embodiment of the present invention has the same configuration as that of the client-server distributed system according to the first embodiment of the present invention, a description thereof will be omitted. An operation of the client-server distributed system according to the second embodiment of the present invention will be described below with reference to FIGS. 1 and 3. Processes of a server apparatus 1 and processes of a client apparatus 3-1 shown in FIG. 3 are realized such that programs are executed by CPUs in the server apparatus 1 and the client apparatus 3-1.

When a user name and a password of the client apparatus 3-1 are input from a maintenance console 5 connected to the server apparatus 1 through a LAN 100 in advance (b11 in FIG. 3), a user name/password input interface unit 12 receives a setting request including the user name/password data (b12 in FIG. 3). When the normality of the user name and the password can be confirmed, the user name/password input interface unit 12 communicates the user name and the password to a user name/password setting unit 11. The user name/password setting unit 11 stores the user name and the password (b21 in FIG. 3), and setting completion is transmitted from the user name/password input interface unit 12 to the local maintenance console 5 (b22 in FIG. 3).

When a server name of the server apparatus 1 and a user name and a password of the client apparatus 3-1 are input from the maintenance console 5 connected to the client apparatus 3-1 through the LAN 100 in advance (b13 in FIG. 3), a server name/user name/password input interface unit 32 receives a setting request including the server name/user name/password data (b14 in FIG. 3). When the normality of the server name, the user name, and the password can be confirmed, the server name/user name/password input interface unit 32 communicates the server name, the user name, and the password to a user name/password setting unit 31. The user name/password setting unit 31 stores the server name, the user name, and the password (b31 in FIG. 3), and setting completion is transmitted from the server name/user name/password input interface unit 32 to the local maintenance console 5 (b32 in FIG. 3). In this case, the user name and the password input to the server apparatus 1 and the client apparatus 3-1 are values (same values) shared by the server apparatus 1 and the client apparatus 3-1.

The setting of the user name and the password of the client apparatus 3-1 in the client apparatus 3-1, the setting of the server name of the server apparatus 1 in the client apparatus 3-1, and the setting of the user name and the password of the client apparatus 3-1 are ended. Since an operation (b23 to b26 and b33 to b36) performed after the client apparatus 3-1 is started are the same as those in the first embodiment of the present invention described above, a description thereof will be omitted.

Therefore, in the embodiment, the settings are performed by using the maintenance console 5 connected to the server apparatus 1 and the client apparatus 3-1 through the LAN 100, so that the facility of maintenance can be assured. Although the operations of the client apparatuses 3-2 and 3-3 are not described, the same effect as that obtained when the client apparatus 3-1 is used can be obtained.

### Third Embodiment

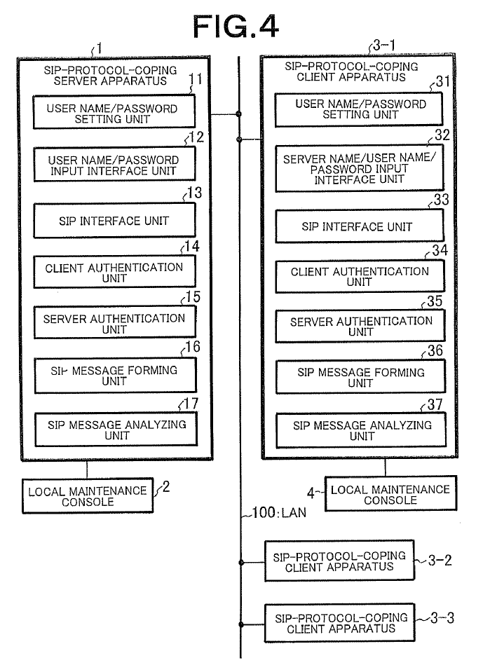

FIG. 4 is a block diagram showing a configuration of an SIP-protocol-coping client-server distributed system according to a third embodiment of the present invention. In FIG. 4, the client-server distributed system according to the third embodiment of the present invention has the same configuration as that of the client-server distributed system according to the first embodiment of the present invention shown in FIG. 1 except for the maintenance console 5 connected to the LAN 100, the same reference numerals as in the first embodiment denote the same parts in the third embodiment. In the third embodiment of the present invention, when client authentication and server authentication are performed, Challenges (to be referred to as inverse Challenges hereinafter) for server authentication and inverse Digest authentication are generated in client apparatuses 3-1 to 3-3, and formation of a Digest (to be referred to an inverse Digest hereinafter) is formed in the server apparatus 1.

In the embodiment, when the following configuration is realized, the client apparatuses 3-1 to 3-3 can be authenticated from the server apparatus 1, and the server apparatus 1 can be authenticated from the client apparatuses 3-1 to 3-3.

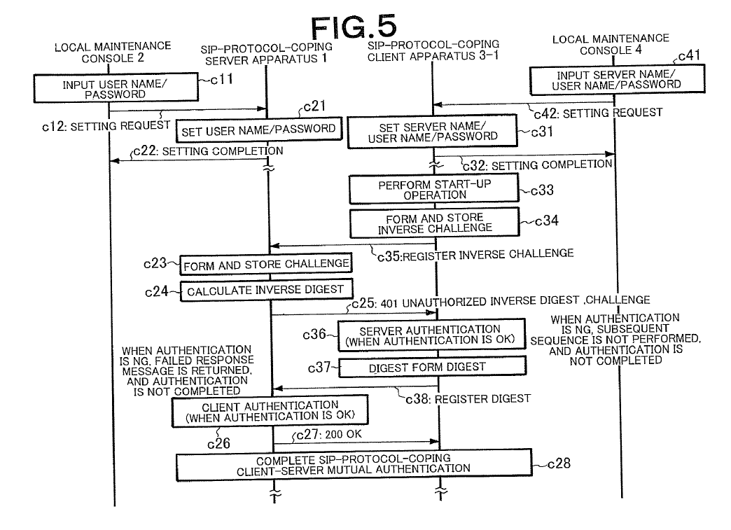

FIG. 5 is a sequence chart showing an operation of an SIP-protocol-coping client-server distributed system according to the third embodiment of the present invention. The operation of the client-server distributed system according to the third embodiment of the present invention will be described below with reference to FIGS. 4 and 5. Processes of the server apparatus 1 and processes of the client apparatus 3-1 shown in FIG. 5 are realized such that programs are executed by CPUs in the server apparatus 1 and the client apparatus 3-1.

When a user name and a password of the client apparatus 3-1 are input from a maintenance console 2 connected to the server apparatus 1 in advance (c11 in FIG. 5), a user name/password input interface unit 12 receives a setting request including the user name/password data (c12 in FIG. 5). When the normality of the user name and the password can be confirmed, the user name/password input interface unit 12 communicates the user name and the password to a user name/password setting unit 11. The user name/password setting unit 11 stores the user name and the password (c21 in FIG. 5), and setting completion is transmitted from the user name/password input interface unit 12 to the local maintenance console 2 (c22 in FIG. 5).

When a server name of the server apparatus 1 and a user name and a password of the client apparatus 3-1 are input from a maintenance console 4 connected to the client apparatus 3-1 in advance (c41 in FIG. 5), a server name/user name/password input interface unit 32 receives a setting request including the server name/user name/password data (c42 in FIG. 5). When the normality of the server name, the user name, and the password can be confirmed, the server name/user name/password input interface unit 32 communicates the server name, the user name, and the password to a user name/password setting unit 31. The user name/password setting unit 31 stores the server name, the user name, and the password (c31 in FIG. 5), and setting completion is transmitted from the server name/user name/password input interface unit 32 to the local maintenance console 4 (c32 in FIG. 5). In this case, the user name and the password input to the server apparatus 1 and the client apparatus 3-1 are values (same values) shared by the server apparatus 1 and the client apparatus 3-1.

After the server name, the user name, and the password are set in the user name/password setting unit 31, when the client apparatus 3-1 is started up (c32 in FIG. 5), the server authentication unit 35 forms an inverse Challenge, designates the SIP message forming unit 36 to form a REGISTER message added with the inverse Challenge, and stores the inverse Challenge (c33 in FIG. 5). The SIP message forming unit 36 transfers the formed REGISTER message to the SIP interface unit 33. The SIP interface unit 33 transmits the REGISTER message to the SIP interface unit 13 of the server apparatus 1 through the LAN 100 (c33 in FIG. 5).

The SIP interface unit 13 which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates the client authentication unit 14 to start authentication of the client apparatus 3-1 and notifies a server authentication unit 15 of the inverse Challenge data.

The client authentication unit 14 which is designated to start the authentication of the client apparatus 3-1 forms a Challenge, designates the SIP message forming unit 16 to form a 401 response message (401 Unauthorized) added with the Challenge, and stores the Challenge (c23 in FIG. 5). At the same time, the server authentication unit 15 forms an inverse Digest (c24 in FIG. 5) and designates the SIP message forming unit 16 to form a 401 response message added with the inverse Digest.

The SIP message forming unit 16 forms 401 response messages added with the Challenge and the inverse challenge and transfers the formed 401 response messages to the SIP interface unit 13. The SIP interface unit 13 transmits the 401 response messages to the SIP interface unit 33 of the client apparatus 3-1 through the LAN 100.

The SIP interface unit 33 of the client apparatus 3-1 which receives the 401 response messages added with the Challenge and the Inverse Digest confirms the normality of formats or the like of the 401 response messages. When the 401 response messages are normal, the SIP interface unit 33 transfers the 401 response messages to the SIP message analyzing unit 37. When the received messages are the 401 response messages added with the Challenge and the inverse Digest, the SIP message analyzing unit 37 notifies the client authentication unit 34 of the Challenge data and notifies the server authentication unit 35 of the inverse Digest data.

The server authentication unit 35 authenticates the received inverse Digest (server authentication) (c36 in FIG. 5). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement, forms a Digest, and designates the SIP message forming unit 36 to form a REGISTER message added with the Digest. The SIP message forming unit 36 transfers the formed REGISTER message to the SIP interface unit 33. The SIP interface unit 33 transmits the REGISTER message to the SIP interface unit 13 of the server apparatus 1 through the LAN 100 (c37 in FIG. 5).

The SIP interface unit 13 of the server apparatus 1 which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (c26 in FIG. 5). When the Digest is authenticated, the client authentication unit 14 completes the authentication of the client apparatus 3-1 and designates the SIP message forming unit 16 to form a 200 response message (200 OK). The SIP message forming unit 16 transfers the formed 200 response message to the SIP interface unit 13. The SIP interface unit 13 transmits the 200 response message to the SIP interface unit 33 of the client apparatus 3-1 through the LAN 100 (c27 in FIG. 5).

The SIP interface unit 33 of the client apparatus 3-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception. The client authentication unit 34 recognizes client authentication achievement in response to the client authentication achievement response reception notification (c28 in FIG. 5).

Therefore, in the embodiment, in addition to the effects in the first and second embodiments of the present invention, since the client apparatus 3-1 does not complete the authentication until the server authentication of the corresponding server apparatus 1 is achieved, security in the SIP-protocol-coping client-server distributed system can be reinforced.

In the embodiment, server authentication performed by reversely defining client authentication is defined and used in the authentication method from the client apparatus 3-1 to the server apparatus 1. The configuration constituted by the client authentication units 14 and 34 and the configuration constituted by the server authentication units 15 and 35 can be structured with a common architecture to make it possible to promote the efficiency of apparatus development. Although the operations of the client apparatuses 3-2 and 3-3 are not described above, the same effect as that obtained when the client apparatus 3-1 is used can be obtained.

### Fourth Embodiment

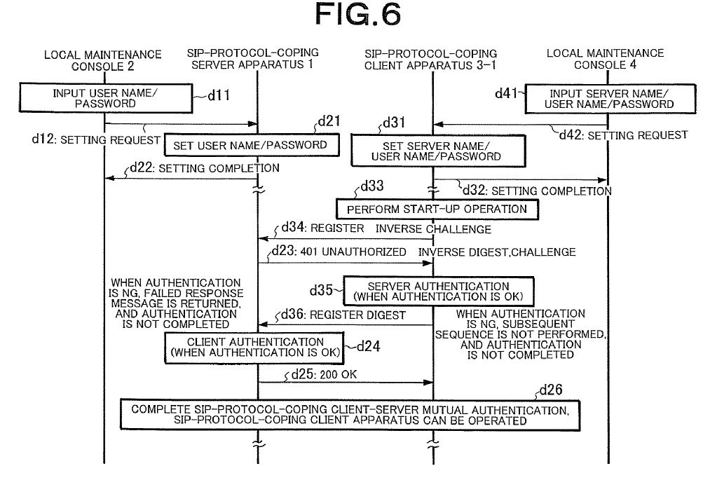

FIG. 6 is a sequence chart showing an operation of an SIP-protocol-coping client-server distributed system according to a fourth embodiment of the present invention. Since the client-server distributed system according to the fourth embodiment of the present invention has the same configuration as that of the client-server distributed system according to the third embodiment of the present invention shown in FIG. 4, a description thereof will be omitted. The client-server distributed system according to the fourth embodiment of the present invention is different from the client-server distributed system according to the third embodiment of the present invention in that authentication achievement is recognized when both client authentication and server authentication are achieved.

The operation of the client-server distributed system according to the fourth embodiment of the present invention will be described below with reference to FIGS. 4 and 6. Processes of a server apparatus 1 and processes of a client apparatus 3-1 shown in FIG. 6 are realized such that programs are executed by CPUs in the server apparatus 1 and the client apparatus 3-1.

When a user name and a password of the client apparatus 3-1 are input from a local maintenance console 2 connected to the server apparatus 1 in advance (d11 in FIG. 6), a user name/password input interface unit 12 receives a setting request including the user name/password data (d12 in FIG. 6). When the normality of the user name and the password can be confirmed, the user name/password input interface unit 12 communicates the user name and the password to the user name/password setting unit 11. The user name/password setting unit 11 stores the user name and the password (d21 in FIG. 6), and setting completion is transmitted from the user name/password input interface unit 12 to the local maintenance console 2 (d22 in FIG. 6).

When a server name of the server apparatus 1 and a user name and a password of the client apparatus 3-1 are input from the local maintenance console 4 connected to the client apparatus 3-1 in advance (d41 in FIG. 6), the server name/user name/password input interface unit 32 receives a setting request including the server name/user name/password data (d42 in FIG. 6). When the normality of the server name, the user name, and the password can be confirmed, the server name/user name/password input interface unit 32 communicates the server name, the user name, and the password to the user name/password setting unit 31. The user name/password setting unit 31 stores the server name, the user name, and the password (d31 in FIG. 6), and setting completion is transmitted from the server name/user name/password input interface unit 32 to the local maintenance console 4 (d32 in FIG. 6). In this case, the user name and the password input to the server apparatus 1 and the client apparatus 3-1 are values (same values) shared by the server apparatus 1 and the client apparatus 3-1.

After the server name, the user name, and the password are set in the user name/password setting unit 31, when the client apparatus 3-1 is started up (d33 in FIG. 6), the server authentication unit 35 forms a Challenge (to be referred to as an inverse Challenge hereinafter) for server authentication, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1 through the LAN 100 (d34 in FIG. 6).

The SIP interface unit 13 which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3-1 and notifies a server authentication unit 15 of the inverse Challenge data.

The client authentication unit 14 which is designated to start the authentication of the client apparatus 3-1 forms a Challenge, designates an SIP message forming unit 16 to form a 401 response message (401 Unauthorized) added with the Challenge, and stores the Challenge. At the same time, the server authentication unit 15 forms a Digest (to be referred to as an inverse Digest hereinafter) for server authentication and designates the SIP message forming unit 16 to form a 401 response message added with the inverse Digest. The SIP message forming unit 16 forms 401 response messages added with the Challenge and the inverse Digest and transfers the formed 401 response messages to the SIP interface unit 13. The SIP interface unit 13 transmits the 401 response messages to the SIP interface unit 33 of the client apparatus 3-1 through the LAN 100 (d23 in FIG. 6).

The SIP interface unit 33 of the client apparatus 3-1 which receives the 401 response messages added with the Challenge and the inverse digest confirms the normality of formats or the like of the 401 response messages. When the 401 response messages are normal, the SIP interface unit 33 transfers the 401 response messages to the SIP message analyzing unit 37. When the received messages are the 401 response messages added with the Challenge and the inverse Digest, the SIP message analyzing unit 37 notifies the client authentication unit 34 of the Challenge data and notifies the server authentication unit 35 of the inverse Digest data.

The server authentication unit 35 authenticates the received inverse Digest (server authentication) (d35 in FIG. 6). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement, forms a Digest, and designates the SIP message forming unit 36 to form a REGISTER message added with the Digest. The SIP message forming unit 36 transfers the formed REGISTER message to the SIP interface unit 33. The SIP interface unit 33 transmits the REGISTER message to the SIP interface unit 13 of the server apparatus 1 through the LAN 100 (d36 in FIG. 6).

The SIP interface unit 13 of the server apparatus 1 which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (c24 in FIG. 6). When the Digest is authenticated, the client authentication unit 14 completes the authentication of the client apparatus 3-1, permits an operation of the client apparatus 3-1 in the SIP-protocol-coping client-server distributed system including the server apparatus 1, and designates the SIP message forming unit 16 to form a 200 response message (200 OK). The SIP message forming unit 16 transfers the formed 200 response message to the SIP interface unit 13. The SIP interface unit 13 transmits the 200 response message to the SIP interface unit 33 of the client apparatus 3-1 through the LAN 100 (d25 in FIG. 6).

The SIP interface unit 33 of the client apparatus 3-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception. The client authentication unit 34 recognizes client authentication achievement in response to the client authentication achievement response reception notification and starts an operation of the client apparatus 3-1 in the SIP-protocol-coping client-server distributed system including the server apparatus 1.

In this manner, in the embodiment, in addition to the effects in the first to third embodiments of the present invention, the operation of the SIP-protocol-coping client-server distributed system of the client apparatus 3-1 is not permitted unless the client authentication of the client apparatus 3-1 from the server apparatus 1 and the server authentication of the server apparatus 1 from the client apparatus 3-1 are achieved to prevent bidirectional spoofing between the client apparatus 3-1 and the server apparatus 1 to make it possible to reinforce the security. Although the operations of the client apparatuses 3-2 and 3-3 are not described above, the same effect as that obtained when the client apparatus 3-1 is used can be obtained.

### Fifth Embodiment

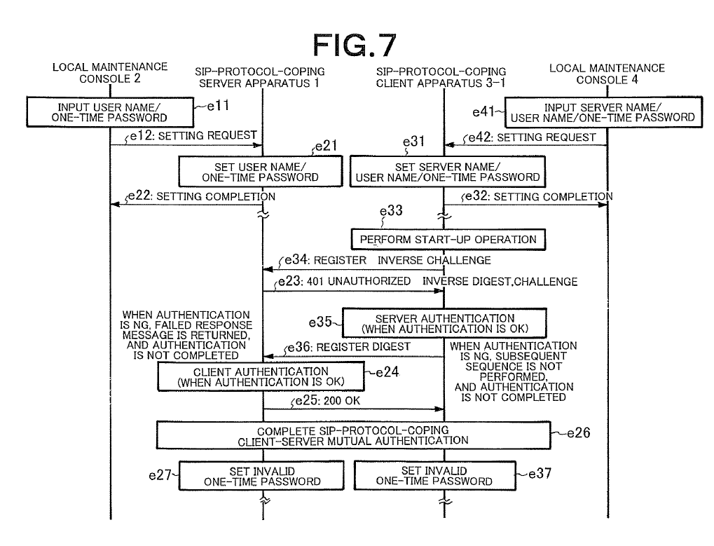

FIG. 7 is a sequence chart showing an operation of an SIP-protocol-coping client-server distributed system according to a fifth embodiment of the present invention. Since the client-server distributed system according to the fifth embodiment of the present invention has the same configuration as that of the client-server distributed system according to the third embodiment of the present invention shown in FIG. 4, a description thereof will be omitted. The client-server distributed system according to the fifth embodiment of the present invention is different from the client-server distributed system according to the third embodiment of the present invention in that a one-time password is used in initial authentication.

An operation of the client-server distributed system according to the fifth embodiment of the present invention will be described below with reference to FIGS. 4 and 7. Processes the Since the client apparatus 3-1 does not complete the authentication until the server authentication of the corresponding server apparatus 1 is achieved, security in the SIP-protocol-coping client-server distributed system can be reinforced.

When a user name and a password of the client apparatus 3-1 are input from a local maintenance console 2 connected to the server apparatus 1 in advance (e11 in FIG. 7), a user name/password input interface unit 12 receives a setting request including the user name/password data (e12 in FIG. 7). When the normality of the user name and the password can be confirmed, the user name/password input interface unit 12 communicates the user name and the password to the user name/password setting unit 11. The user name/password setting unit 11 stores the user name and the password (e21 in FIG. 7), and setting completion is transmitted from the user name/password input interface unit 12 to the local maintenance console 2 (e22 in FIG. 7).

When a server name of the server apparatus 1 and a user name and a password of the client apparatus 3-1 are input from the local maintenance console 4 connected to the client apparatus 3-1 in advance (e41 in FIG. 7), the server name/user name/password input interface unit 32 receives a setting request including the server name/user name/password data (e42 in FIG. 7). When the normality of the server name, the user name, and the password can be confirmed, the server name/user name/password input interface unit 32 communicates the server name, the user name, and the password to the user name/password setting unit 31. The user name/password setting unit 31 stores the server name, the user name, and the password (e31 in FIG. 7), and setting completion is transmitted from the server name/user name/password input interface unit 32 to the local maintenance console 4 (e32 in FIG. 7). In this case, the user name and the password input to the server apparatus 1 and the client apparatus 3-1 are values (same values) shared by the server apparatus 1 and the client apparatus 3-1.

After the server name, the user name, and the password are set in the user name/password setting unit 31, when the client apparatus 3-1 is started up (e33 in FIG. 7), the server authentication unit 35 forms an inverse Challenge, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1 through the LAN 100 (e34 in FIG. 7).

The SIP interface unit 13 which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3-1 and notifies a server authentication unit 15 of the inverse Challenge data.

The client authentication unit 14 which is designated to start the authentication of the client apparatus 3-1 forms a Challenge, designates an SIP message forming unit 16 to form a 401 response message (401 Unauthorized) added with the Challenge, and stores the Challenge. At the same time, the server authentication unit 15 forms an inverse Digest and designates the SIP message forming unit 16 to form a 401 response message added with the inverse Digest. The SIP message forming unit 16 forms 401 response messages added with the Challenge and the inverse Digest and transfers the formed 401 response messages to the SIP interface unit 13. The SIP interface unit 13 transmits the 401 response messages to the SIP interface unit 33 of the client apparatus 3-1 through the LAN 100 (e23 in FIG. 7).

The SIP interface unit 33 of the client apparatus 3-1 which receives the 401 response messages added with the Challenge and the inverse digest confirms the normality of formats or the like of the 401 response messages. When the 401 response messages are normal, the SIP interface unit 33 transfers the 401 response messages to the SIP message analyzing unit 37. When the received messages are the 401 response messages added with the Challenge and the inverse Digest, the SIP message analyzing unit 37 notifies the client authentication unit 34 of the Challenge data and notifies the server authentication unit 35 of the inverse Digest data.

The server authentication unit 35 authenticates the received inverse Digest (server authentication) (e35 in FIG. 7). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement, forms a Digest, and designates the SIP message forming unit 36 to form a REGISTER message added with the Digest. The SIP message forming unit 36 forms the REGISTER message added with the Digest and transfers the formed REGISTER message to the SIP interface unit 33. The SIP interface unit 33 transmits the REGISTER message to the SIP interface unit 13 of the server apparatus 1 through the LAN 100 (e36 in FIG. 7).

The SIP interface unit 13 of the server apparatus 1 which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (e24 in FIG. 7). When the Digest is authenticated, the client authentication unit 14 completes the authentication of the client apparatus 3-1, permits an operation of the client apparatus 3-1 in the SIP-protocol-coping client-server distributed system including the server apparatus 1, and designates the SIP message forming unit 16 to form a 200 response message (200 OK). The SIP message forming unit 16 transfers the formed 200 response message to the SIP interface unit 13. The SIP interface unit 13 transmits the 200 response message to the SIP interface unit 33 of the client apparatus 3-1 through the LAN 100 (e25 in FIG. 7).

The client authentication unit 14 designates a user name/password setting unit 11 to make the one-time password invalid. The user name/password setting unit 11 designated to make the one-time password invalid makes the stored one-time password invalid (e27 in FIG. 7).

The SIP interface unit 33 of the client apparatus 3-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception. The client authentication unit 34 recognizes client authentication achievement in response to the client authentication achievement response reception notification and starts an operation of the client apparatus 3-1 in the SIP-protocol-coping client-server distributed system including the server apparatus 1 (e26 in FIG. 7).

The client authentication unit 34 designates a user name/password setting unit 31 to make the one-time password invalid. The user name/password setting unit 31 designated to make the one-time password invalid makes the stored one-time password invalid (e37 in FIG. 7).

In this manner, in the embodiment, in addition to the effects in the first to fourth embodiments of the present invention, a password used in authentication between the client apparatus 3-1 and the server apparatus 1 is set as a one-time password, and the one-time password is made invalid upon completion of the client authentication and the server authentication. Authentication by the same password externally input by a holder is not performed two or more times to prevent a password from artificially flowing out, and security in the SIP-protocol-coping client-server distributed system can be reinforced. Although the operations of the client apparatuses 3-2 and 3-3 are not described above, the same effect as that obtained when the client apparatus 3-1 is used can be obtained.

### Sixth Embodiment

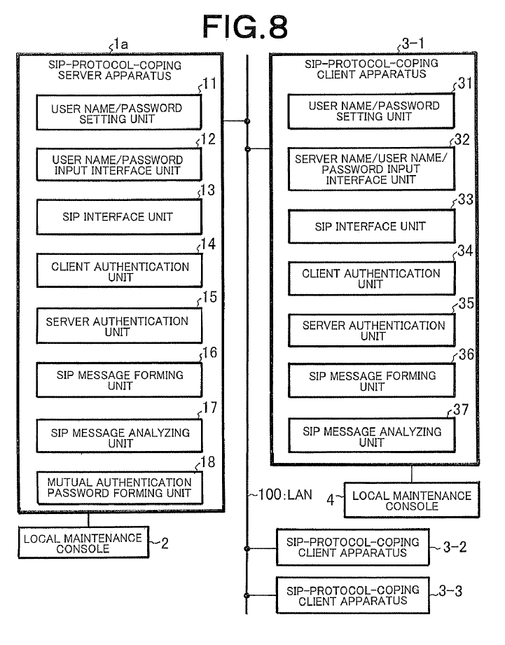

FIG. 8 is a block diagram showing a configuration of an SIP-protocol-coping client-server distributed system according to a sixth embodiment of the present invention. In FIG. 8, the client-server distributed system according to the sixth embodiment of the present invention has the same configuration as that of the client-server distributed system according to the third embodiment of the present invention shown in FIG. 4 except that a mutual authentication password forming unit 18 is added to a server apparatus 1a, and the same reference numerals as in the third embodiment denote the same constituent elements in the sixth embodiment. In the sixth embodiment of the present invention, a mutual authentication password is automatically generated by the mutual authentication password forming unit 18, and the mutual authentication password is set in a client apparatus 3-1.

In this embodiment, the above configuration is realized, the client apparatus 3-1 is authenticated from the server apparatus 1a to make it possible to authenticate the server apparatus 1a from the client apparatus 3-1.

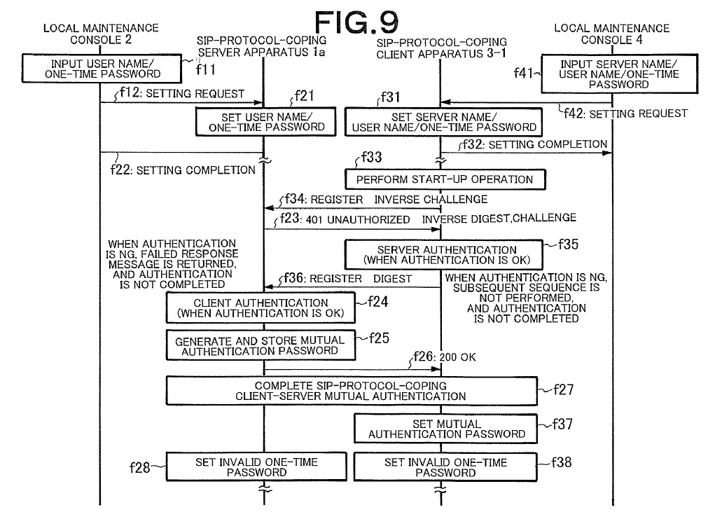

FIG. 9 is a sequence chart showing an operation of the SIP-protocol-coping client-server distributed system according to the sixth embodiment of the present invention. An operation of the client-server distributed system according to the sixth embodiment of the present invention will be described below with reference to FIGS. 8 and 9. Processes of a server apparatus 1a and processes of a client apparatus 3-1 shown in FIG. 9 are realized such that programs are executed by CPUs in the server apparatus 1a and the client apparatus 3-1.

When a user name and a one-time password of the client apparatus 3-1 are input from a local maintenance console 2 connected to the server apparatus 1a in advance (f11 in FIG. 9), a user name/password input interface unit 12 receives a setting request including the user name/one-time password data (f12 in FIG. 9). When the normality of the user name and the one-time password can be confirmed, the user name/password input interface unit 12 communicates the user name and the one-time password to the user name/password setting unit 11. The user name/password setting unit 11 stores the user name and the one-time password (f21 in FIG. 9), and setting completion is transmitted from the user name/password input interface unit 12 to the local maintenance console 2 (f22 in FIG. 9).

When a server name of the server apparatus 1a and a user name and a one-time password of the client apparatus 3-1 are input from the local maintenance console 4 connected to the client apparatus 3-1 in advance (f41 in FIG. 9), the server name/user name/password input interface unit 32 receives a setting request including the server name/user name/one-time password data (e42 in FIG. 9). When the normality of the server name, the user name, and the one-time password can be confirmed, the server name/user name/password input interface unit 32 communicates the server name, the user name, and the one-time password to the user name/password setting unit 31. The user name/password setting unit 31 stores the server name, the user name, and the one-time password (f31 in FIG. 9), and setting completion is transmitted from the server name/user name/password input interface unit 32 to the local maintenance console 4 (f32 in FIG. 9). In this case, the user name and the one-time password input to the server apparatus 1a and the client apparatus 3-1 are values (same values) shared by the server apparatus 1a and the client apparatus 3-1.

After the server name, the user name, and the one-time password are set in the user name/password setting unit 31, when the client apparatus 3-1 is started up (f33 in FIG. 9), the server authentication unit 35 forms an inverse Challenge, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1a through the LAN 100 (f34 in FIG. 9).

The SIP interface unit 13 of the server apparatus 1a which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3-1 and notifies a server authentication unit 15 of the inverse Challenge data.

The client authentication unit 14 which is designated to start the authentication of the client apparatus 3-1 forms a Challenge, designates an SIP message forming unit 16 to form a 401 response message (401 Unauthorized) added with the Challenge, and stores the Challenge. At the same time, the server authentication unit 15 forms an inverse Digest and designates the SIP message forming unit 16 to form a 401 response message added with the inverse Digest.

The SIP message forming unit 16 forms 401 response messages added with the Challenge and the inverse Digest and transfers the formed 401 response messages to the SIP interface unit 13. The SIP interface unit 13 transmits the 401 response messages to the SIP interface unit 33 of the client apparatus 3-1 through the LAN 100 (f23 in FIG. 9).

The SIP interface unit 33 of the client apparatus 3-1 which receives the 401 response messages added with the Challenge and the inverse Digest confirms the normality of formats or the like of the 401 response messages. When the 401 response messages are normal, the SIP interface unit 33 transfers the 401 response messages to the SIP message analyzing unit 37. When the received messages are the 401 response messages added with the Challenge and the inverse Digest, the SIP message analyzing unit 37 notifies the client authentication unit 34 of the Challenge data and notifies the server authentication unit 35 of the inverse Digest data.

The server authentication unit 35 authenticates the received inverse Digest (server authentication) (f35 in FIG. 9). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement, forms a Digest, and designates the SIP message forming unit 36 to form a REGISTER message added with the Digest. The SIP message forming unit 36 forms the REGISTER message added with the Digest and transfers the formed REGISTER message to the SIP interface unit 33. The SIP interface unit 33 transmits the REGISTER message to the SIP interface unit 13 of the server apparatus 1a through the LAN 100 (f36 in FIG. 9).

The SIP interface unit 13 of the server apparatus 1a which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (f24 in FIG. 9). When the Digest is authenticated, the client authentication unit 14 completes the authentication of the client apparatus 3-1 and permits an operation of the client apparatus 3-1 in the SIP-protocol-coping client-server distributed system including the server apparatus 1a. Furthermore, the client authentication unit 14 designates a mutual authentication password forming unit 18 to form a mutual authentication password used in second and subsequent start-up states of the client apparatus 3-1.

The mutual authentication password forming unit 18 forms a random mutual authentication password, and notifies the client authentication unit 14 of the formed mutual authentication password. The client authentication unit 14 notifies the user name/password setting unit 11 of the mutual authentication password and designates the user name/password setting unit 11 to set the mutual authentication password. The user name/password setting unit 11 stores the mutual authentication password (f25 in FIG. 9).

The client authentication unit 14 designates the SIP message forming unit 16 to form a 200 response message added with a mutual authentication password (200 OK). The SIP message forming unit 16 transfers the formed 200 response message to the SIP interface unit 13. The SIP interface unit 13 transmits the 200 response message to the SIP interface unit 33 of the client apparatus 3-1 through the LAN 100 (f26 in FIG. 9).

Furthermore, the client authentication unit 14 designates a user name/password setting unit 11 to make the one-time password invalid. The user name/password setting unit 11 designated to make the one-time password invalid makes the stored one-time password invalid (f28 in FIG. 9).

The SIP interface unit 33 of the client apparatus 3-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception and the mutual authentication password. The client authentication unit 34 recognizes client authentication achievement in response to the client authentication achievement response reception notification and starts an operation of the client apparatus 3-1 in the SIP-protocol-coping client-server distributed system including the server apparatus 1a (f27 in FIG. 9).

The client authentication unit 34 notifies the user name/password setting unit 31 of the mutual authentication password and designates the user name/password setting unit 31 to set the mutual authentication password. The user name/password setting unit 31 designed to set the mutual authentication password stores the mutual authentication password (f37 in FIG. 9).

Furthermore, the client authentication unit 34 designates the user name/password setting unit 31 to make the one-time password invalid. The user name/password setting unit 31 designated to make the one-time password invalid makes the stored one-time password invalid (f38 in FIG. 9).

In this manner, in the embodiment, in addition to the effects in the first to fifth embodiments of the present invention, a mutual authentication password used in the second and subsequent authentications between the client apparatus 3-1 and the server apparatus 1a is automatically generated by the server apparatus 1a. Authentication by the same one-time password externally input by a holder is not performed two or more times to prevent an erroneous input or a one-time password from artificially flowing out, and a password which cannot be easily presumed can be used by forming a random password. For this reason, security in an SIP-protocol-coping client-server distributed system can be reinforced. Although the operations of the client apparatuses 3-2 and 3-3 are not described above, the same effect as that obtained when the client apparatus 3-1 is used can be obtained.

### Seventh Embodiment

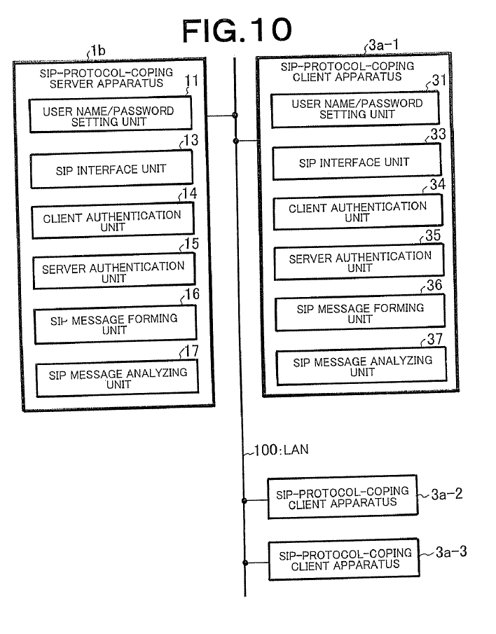

FIG. 10 is a block diagram showing a configuration of an SIP-protocol-coping client-server distributed system according to a seventh embodiment of the present invention. In FIG. 10, the client-server distributed system according to the seventh embodiment of the present invention has the same configuration of the client-server distributed system according to the third embodiment of the present invention shown in FIG. 4 except for a server name/user name/password input interface unit 32 in a client apparatus 3a-1.

In this case, a server apparatus 1b holds a user name and a mutual authentication password of the client apparatus 3a-1 stored at the first start-up state of the client apparatus 3a-1 in a user name/password setting unit 11. The client apparatus 3a-1 holds a server name of the server apparatus 1b and a user name and a mutual authentication password at the first start-up state in the user name/password setting unit 31. In this case, the user name and the mutual authentication password are values (same values) shared by the server apparatus 1b and the client apparatus 3a-1.

In the embodiment, the above configuration is realized to make it possible to authenticate the client apparatus 3a-1 from the server apparatus 1b and to authenticate the server apparatus 1b from the client apparatus 3a-1.

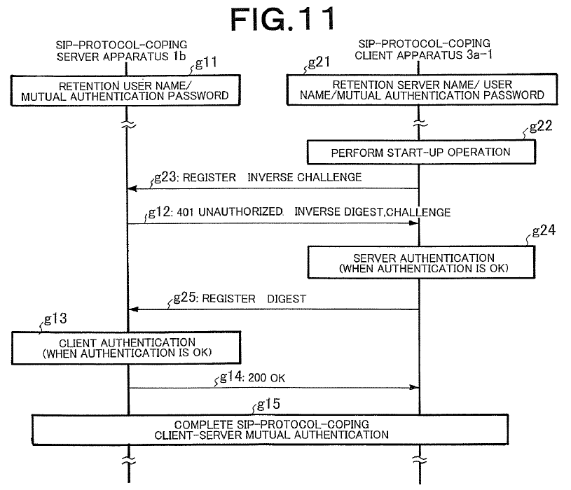

FIG. 11 is a sequence chart showing an operation of the SIP-protocol-coping client-server distributed system according to the seventh embodiment of the present invention. In FIG. 11, the second and subsequent authentication processes in the client-server distributed system according to the seventh embodiment of the present invention. The operation of the client-server distributed system according to the seventh embodiment of the present invention will be described below with reference to FIGS. 10 and 11. Processes of the server apparatus 1b and processes of the client apparatus 3a-1 are realized such that programs are executed by CPUs in the server apparatus 1b and the client apparatus 3a-1.

In a state in which a server name, a user name, and a mutual authentication password are held in the user name/password setting unit 31 of the client apparatus 3a-1 (g21 in FIG. 11), when the client apparatus 3a-1 is started up (g22 in FIG. 11), the server authentication unit 35 forms an inverse Challenge, designates the SIP message forming unit 36 to form a REGISTER message added with the inverse Challenge, and stores the inverse Challenge.

The SIP message forming unit 36 forms the REGISTER message to the SIP interface unit 33. The SIP interface unit 33 transmits the REGISTER message to a SIP interface unit 13 of the server apparatus 1b through the LAN 100 (g23 in FIG. 1).

The SIP interface unit 13 of the server apparatus 1 which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates the client authentication unit 14 to start authentication of the client apparatus 3-1 and notifies the server authentication unit 15 of the inverse Challenge data.

The client authentication unit 14 which is designated to start the authentication of the client apparatus 3a-1 forms a Challenge, designates an SIP message forming unit 16 to form a 401 response message (401 Unauthorized) added with the Challenge, and stores the Challenge. At the same time, the server authentication unit 15 forms an inverse Digest and designates the SIP message forming unit 16 to form a 401 response message added with the inverse Digest.

The SIP message forming unit 16 forms 401 response messages added with the Challenge and the inverse Digest and transfers the formed 401 response messages to the SIP interface unit 13. The SIP interface unit 13 transmits the 401 response messages to the SIP interface unit 33 of the client apparatus 3a-1 through the LAN 100 (g12 in FIG. 11).

The SIP interface unit 33 of the client apparatus 3a-1 which receives the 401 response messages added with the Challenge and the inverse Digest confirms the normality of formats or the like of the 401 response messages. When the 401 response messages are normal, the SIP interface unit 33 transfers the 401 response messages to the SIP message analyzing unit 37. When the received messages are the 401 response messages added with the Challenge and the inverse Digest, the SIP message analyzing unit 37 notifies the client authentication unit 34 of the Challenge data and notifies the server authentication unit 35 of the inverse Digest data.

The server authentication unit 35 authenticates the received inverse Digest (server authentication) (g24 in FIG. 11). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement, forms a Digest, and designates the SIP message forming unit 36 to form a REGISTER message added with the Digest. The SIP message forming unit 36 transfers the formed REGISTER message to the SIP interface unit 33. The SIP interface unit 33 transmits the REGISTER message to the SIP interface unit 13 of the server apparatus 1b through the LAN 100 (g25 in FIG. 11).

The SIP interface unit 13 of the server apparatus 1b which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (g13 in FIG. 11). When the Digest is authenticated, the client authentication unit 14 completes the authentication of the client apparatus 3a-1 and permits an operation of the client apparatus 3-1 in the SIP-protocol-coping client-server distributed system including the server apparatus 1b, and designates the SIP message forming unit 16 to form a 200 response message (200 OK). The SIP message forming unit 16 transfers the formed 200 response message to the SIP interface unit 13. The SIP interface unit 13 transmits the 200 response message to the SIP interface unit 33 of the client apparatus 3a-1 through the LAN 100 (g14 in FIG. 11).

The SIP interface unit 33 of the client apparatus 3a-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception. The client authentication unit 34 recognizes client authentication achievement in response to the client authentication achievement response reception notification and starts an operation of the client apparatus 3a-1 in the SIP-protocol-coping client-server distributed system including the server apparatus 1b (g15 in FIG. 11).

In this manner in the embodiment, in addition to the effect of the sixth embodiment of the present invention, a password used in mutual authentication in REGISTER state between the client apparatus 3a-1 and the server apparatus 1b is a password generated at random by the server apparatus 1b in the first start-up state. Since setting is not performed by an external input, security can be reinforced to prevent an artificial erroneous input and improve confidential property of a password. Although the operations of the client apparatuses 3a-2 and 3a-3 are not described above, the same effect as that obtained when the client apparatus 3a-1 is used can be obtained.

### Eighth Embodiment

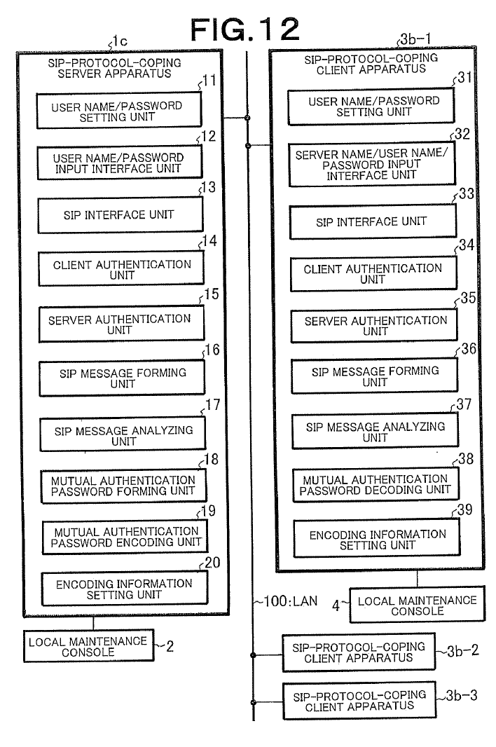

FIG. 12 is a block diagram showing a configuration of an SIP-protocol-coping client-server distributed system according to an eighth embodiment of the present invention. In FIG. 12, the client-server distributed system according to the eighth embodiment of the present invention has the same configuration as that of the client-server distributed system according to the sixth embodiment of the present invention shown in FIG. 8 except that a mutual authentication password encoding unit 19 and an encoding information setting unit 20 are added to a server apparatus 1c and a mutual authentication password decoding unit 38 and an encoding information setting unit 39 are added to client apparatuses 3b-1 to 3b-3, and the same reference numerals as in the sixth embodiment denote the same parts in the eighth embodiment. In the eighth embodiment of the present invention, a mutual authentication password is encoded in the server apparatus 1c, and the mutual authentication passwords are decoded in the client apparatuses 3b-1 to 3b-3.

In the embodiment, by realizing the above configuration, the client apparatuses 3b-1 to 3b-3 are authenticated from the server apparatus 1c, and the server apparatus 1c can be authenticated from the client apparatuses 3b-1 to 3b-3.

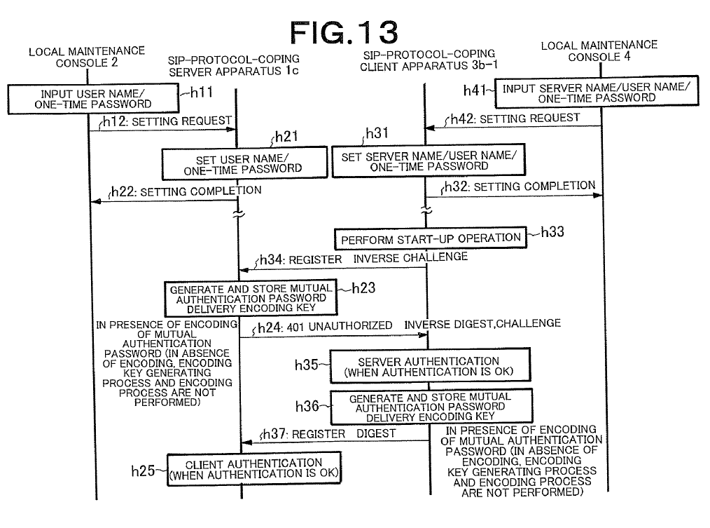

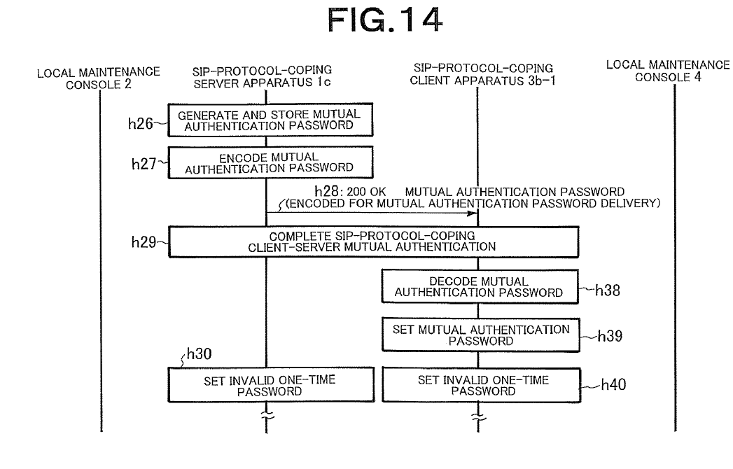

FIGS. 13 and 14 are sequence charts showing an operation of the SIP-protocol-coping client-server distributed system according to the eighth embodiment of the present invention. The operation of the client-server distributed system according to the eighth embodiment of the present invention will be described below with reference to FIGS. 12 to 14. Processes of the server apparatus 1c and processes of the client apparatus 3b-1 are realized such that programs are executed by CPUs of the server apparatus 1c and the client apparatus 3b-1.

When a user name and a one-time password of the client apparatus 3b-1 are input from a local maintenance console 2 connected to the server apparatus 1c in advance (h11 in FIG. 13), a user name/password input interface unit 12 receives a setting request including the user name/one-time password data (h12 in FIG. 13). When the normality of the user name and the one-time password can be confirmed, the user name/password input interface unit 12 communicates the user name and the one-time password to the user name/password setting unit 11. The user name/password setting unit 11 stores the user name and the one-time password (h21 in FIG. 13), and setting completion is transmitted from the user name/password input interface unit 12 to the local maintenance console 2 (h22 in FIG. 13).

When a server name of the server apparatus 1c and a user name and a one-time password of the client apparatus 3b-1 are input from the local maintenance console 4 connected to the client apparatus 3b-1 in advance (h41 in FIG. 13), the server name/user name/password input interface unit 32 receives a setting request including the server name/user name/one-time password data (h42 in FIG. 13). When the normality of the server name, the user name, and the one-time password can be confirmed, the server name/user name/password input interface unit 32 communicates the server name, the user name, and the one-time password to the user name/password setting unit 31. The user name/password setting unit 31 stores the server name, the user name, and the one-time password (h31 in FIG. 13), and setting completion is transmitted from the server name/user name/password input interface unit 32 to the local maintenance console 4 (h32 in FIG. 13). In this case, the user name and the one-time password input to the server apparatus 1c and the client apparatus 3b-1 are values (same values) shared by the server apparatus 1c and the client apparatus 3b-1.

After the server name, the user name, and the one-time password are set in the user name/password setting unit 31, when the client apparatus 3b-1 is started up (h33 in FIG. 13), the server authentication unit 35 forms an inverse Challenge, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1c through the LAN 100 (h34 in FIG. 13).

The SIP interface unit 13 of the server apparatus 1c which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3b-1 and notifies a server authentication unit 15 of the inverse Challenge data.

The client authentication unit 14 which is designated to start the authentication of the client apparatus 3b-1 forms a Challenge, designates an SIP message forming unit 16 to form a 401 response message (401 Unauthorized) added with the Challenge, and stores the Challenge. The client authentication unit 14 designates the encoding information setting unit 20 to generate a mutual authentication password delivery encoding key used when a mutual authentication password is encoded and transmitted when the mutual authentication password used in mutual authentication in the second and subsequent REGISTER states is delivered. The encoding information setting unit 20 generates and stores the mutual authentication password delivery encoding key (h23 in FIG. 13).

At the same time, the server authentication unit 15 forms an inverse Digest and designates the SIP message forming unit 16 to form a 401 response message added with the inverse Digest. The SIP message forming unit 16 forms 401 response messages added with the Challenge and the inverse Digest and transfers the formed 401 response messages to the SIP interface unit 13. The SIP interface unit 13 transmits the 401 response messages to the SIP interface unit 33 of the client apparatus 3b-1 through the LAN 100 (h24 in FIG. 13).

The SIP interface unit 33 of the client apparatus 3b-1 which receives the 401 response messages added with the Challenge and the inverse Digest confirms the normality of formats or the like of the 401 response messages. When the 401 response messages are normal, the SIP interface unit 33 transfers the 401 response messages to the SIP message analyzing unit 37. When the received messages are the 401 response messages added with the Challenge and the inverse Digest, the SIP message analyzing unit 37 notifies the client authentication unit 34 of the Challenge data and notifies the server authentication unit 35 of the inverse Digest data.

The server authentication unit 35 authenticates the received inverse Digest (server authentication) (h35 in FIG. 13). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement and designates the SIP message forming unit 36 to form a REGISTER message added with the Digest.

The client authentication unit 34 designates the encoding information setting unit 39 to generate a mutual authentication password delivery encoding key used when a mutual authentication password is encoded and transmitted when a mutual authentication password used in mutual authentication in the second and subsequent REGISTER states is delivered. The encoding information setting unit 39 generates and stores the mutual authentication password delivery encoding key (h36 in FIG. 13).

The SIP message forming unit 36 transfers the formed REGISTER message to the SIP interface unit 33. The SIP interface unit 33 transmits the REGISTER message to the SIP interface unit 13 of the server apparatus 1c through the LAN 100 (h37 in FIG. 13).

The SIP interface unit 13 of the server apparatus 1c which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (h25 in FIG. 13). When the Digest is authenticated, the client authentication unit 14 completes the authentication of the client apparatus 3b-1 and permits an operation of the client apparatus 3b-1 in the SIP-protocol-coping client-server distributed system including the server apparatus 1c.

Furthermore, the client authentication unit 14 designates a mutual authentication password forming unit 18 to form a mutual authentication password used in second and subsequent start-up states of the client apparatus 3b-1. The mutual authentication password forming unit 18 forms a random mutual authentication password, and notifies the client authentication unit 14 of the formed mutual authentication password. The client authentication unit 14 notifies the user name/password setting unit 11 of the mutual authentication password and designates the user name/password setting unit 11 to set the mutual authentication password. The user name/password setting unit 11 stores the mutual authentication password (h26 in FIG. 14).

The client authentication unit 14 designates the mutual authentication password encoding unit 19 to encode the formed mutual authentication password. The mutual authentication password encoding unit 19 asks the encoding information setting unit 20 about an encoding rule and a mutual authentication password delivery encoding key, encodes the formed mutual authentication password by the read encoding rule and the read mutual authentication password delivery encoding key, and notifies the client authentication unit 14 of the encoded mutual authentication password (h27 in FIG. 14).

The client authentication unit 14 designates the SIP message forming unit 16 to form a 200 response message added with an encoded mutual authentication password (200 OK). The SIP message forming unit 16 transfers the formed 200 response message to the SIP interface unit 13. The SIP interface unit 13 transmits the 200 response message to the SIP interface unit 33 of the client apparatus 3b-1 through the LAN 100 (h28 in FIG. 14).

Furthermore, the client authentication unit 14 designates a user name/password setting unit 11 to make the one-time password invalid. The user name/password setting unit 11 designated to make the one-time password invalid makes the stored one-time password invalid (h30 in FIG. 14).

The SIP interface unit 33 of the client apparatus 3b-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception and the encoded mutual authentication password.

The client authentication unit 34 recognizes client authentication achievement in response to the client authentication achievement response reception notification and starts an operation of the client apparatus 3b-1 in the SIP-protocol-coping client-server distributed system including the server apparatus 1 (h29 in FIG. 14).

The client authentication unit 34 designates the mutual authentication password decoding unit 38 to decode the received mutual authentication password. The mutual authentication password decoding unit 38 asks the encoding information setting unit 39 about an encoding rule and an authentication password delivery encoding key, decodes the mutual authentication password received by the SIP interface unit 33 by the read encoding rule and the read mutual authentication password delivery encoding key, and notifies the client authentication unit 34 of the decoded mutual authentication password (h38 in FIG. 14).

The client authentication unit 34 notifies the user name/password setting unit 31 of the decoded mutual authentication password and designates the user name/password setting unit 31 to set the mutual authentication password. The user name/password setting unit 31 designed to set the mutual authentication password stores the mutual authentication password (h39 in FIG. 14). Furthermore, the client authentication unit 34 designates the user name/password setting unit 31 to make the one-time password invalid. The user name/password setting unit 31 designated to make the one-time password invalid makes the stored one-time password invalid (h40 in FIG. 14).

In this manner, in the embodiment, in addition to the effect in the sixth embodiment of the present invention, data is encoded when a mutual authentication password used in the second and subsequent authentications between the client apparatus 3b-1 and the server apparatus 1c is transmitted from the server apparatus 1c to make it possible to reinforce the security against leakage of data in notification of a password or intentional hacking or the like. Although the operations of client apparatuses 3b-2 and 3b-3 are not described above, the same effect as that obtained when the client apparatus 3b-1 is used can be obtained.

### Ninth Embodiment

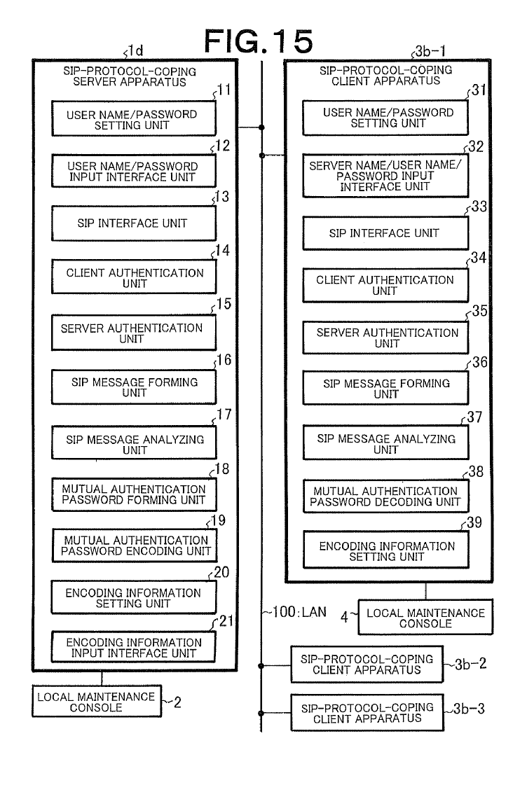

FIG. 15 is a block diagram showing a configuration of an SIP-protocol-coping client-server distributed system according to a ninth embodiment of the present invention. In FIG. 15, the client-server distributed system according to the ninth embodiment of the present invention has the same configuration as that of the client-server distributed system according to the eighth embodiment of the present invention shown in FIG. 12 except that an encoding information input interface unit 21 is added to a server apparatus 1d, and the same reference numerals as in the eighth embodiment denote the same parts in the ninth embodiment. In the ninth embodiment of the present invention, the presence/absence of encoding of a mutual authentication password is set from the encoding information input interface unit 21 in a server apparatus 1c.

In the embodiment, the above configuration is realized to make it possible to authenticate a client apparatus 3b-1 from the server apparatus id and to authenticate the server apparatus 1d from the client apparatus 3b-1.

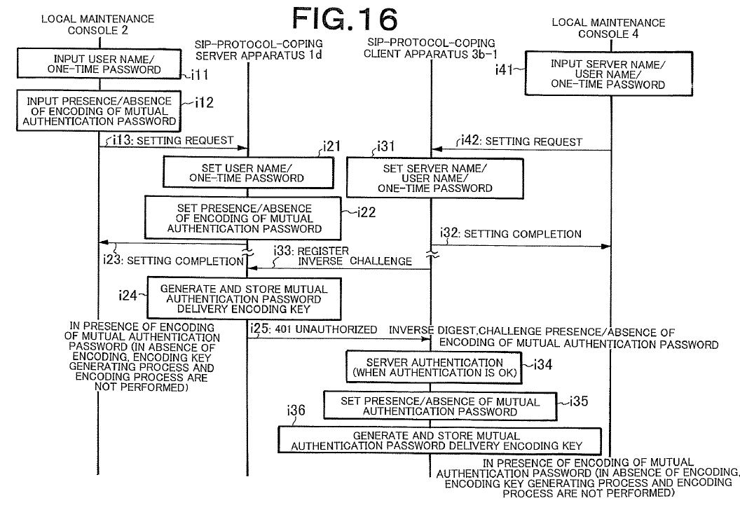

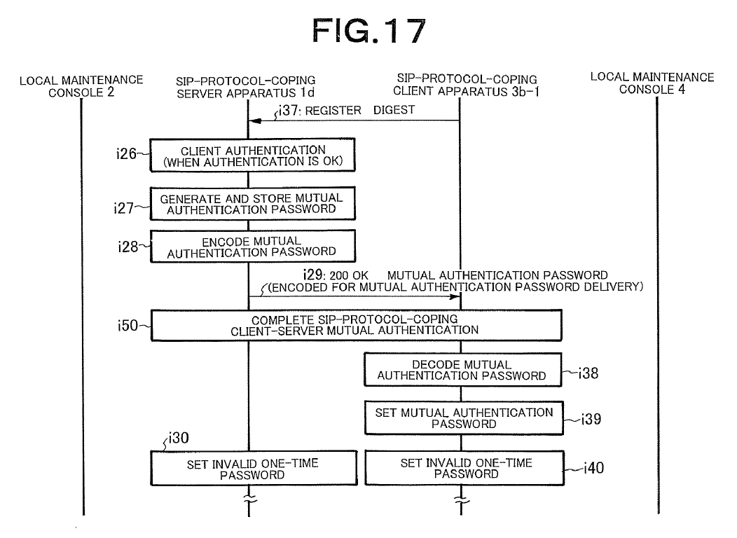

FIGS. 16 and 17 are sequence charts showing an operation of the SIP-protocol-coping client-server distributed system according to the ninth embodiment of the present invention. The operation of the client-server distributed system according to the ninth embodiment of the present invention will be described below with reference to FIGS. 15 to 17. Processes of the server apparatus 1d and processes of the client apparatus 3b-1 shown in FIGS. 16 and 17 are realized such that programs are executed by CPUs of the server apparatus 1d and the client apparatus 3b-1.

When a user name, a one-time password, and the presence/absence of encoding of a mutual authentication password of the client apparatus 3b-1 are input from a local maintenance console 2 connected to the server apparatus 1d in advance (i11 in FIG. 16), a user name/password input interface unit 12 receives a setting request including the user name/one-time password data (i12 in FIG. 16). When the normality of the user name and the one-time password can be confirmed, the user name/password input interface unit 12 communicates the user name and the one-time password to the user name/password setting unit 11. The user name/password setting unit 11 stores the user name and the one-time password (i21 in FIG. 16).

The encoding information input interface unit 21 receives a setting request including the presence/absence data of encoding of the mutual authentication password. When the normality of the presence/absence data of encoding of the mutual authentication password can be confirmed, the encoding information input interface unit 21 communicates the presence/absence data of encoding of the mutual authentication password to the encoding information setting unit 20. The encoding information setting unit 20 stores the presence/absence of encoding of the mutual authentication password (i22 in FIG. 16). Thereafter, the user name/password setting unit 11 transmits setting completion from the user name/password input interface unit 12 to the local maintenance console 2 (i23 in FIG. 16).

When a server name of the server apparatus 1d and a user name and a one-time password of the client apparatus 3b-1 are input from the local maintenance console 4 connected to the client apparatus 3b-1 in advance (i41 in FIG. 16), the server name/user name/password input interface unit 32 receives a setting request including the server name/user name/one-time password data (i42 in FIG. 16). When the normality of the server name, the user name, and the one-time password can be confirmed, the server name/user name/password input interface unit 32 communicates the server name, the user name, and the one-time password to the user name/password setting unit 31. The user name/password setting unit 31 stores the server name, the user name, and the one-time password (i31 in FIG. 16), and setting completion is transmitted from the server name/user name/password input interface unit 32 to the local maintenance console 4 (i32 in FIG. 16). In this case, the user name and the one-time password input to the server apparatus 1d and the client apparatus 3b-1 are values (same values) shared by the server apparatus 1d and the client apparatus 3b-1.

After the server name, the user name, and the one-time password are set in the user name/password setting unit 31, when the client apparatus 3b-1 is started up, the server authentication unit 35 forms an inverse Challenge, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1d through the LAN 100 (i33 in FIG. 16).

The SIP interface unit 13 of the server apparatus 1d which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3b-1 and notifies a server authentication unit 15 of the inverse Challenge data.

The client authentication unit 14 which is designated to start the authentication of the client apparatus 3b-1 forms a Challenge, designates an SIP message forming unit 16 to form a 401 response message (401 Unauthorized) added with the Challenge, and stores the Challenge. The client authentication unit 14 asks the encoding information setting unit 20 whether a mutual authentication password is encoded and transmitted when the mutual authentication password used in mutual authentication in the second and subsequent REGISTER states. At the presence of encoding, the client authentication unit 14 designates the encoding information setting unit 20 to generate a mutual authentication password delivery encoding key. The encoding information setting unit 20 generates and stores the mutual authentication password delivery encoding key (i24 in FIG. 16).

At the same time, the server authentication unit 15 forms an inverse Digest and designates the SIP message forming unit 16 to form 401 response messages added with the inverse Digest and the presence/absence data of encoding of the mutual authentication password. The SIP message forming unit 16 forms 401 response messages added with the Challenge, the inverse Digest, and the presence/absence data of encoding of the mutual authentication password and transfers the formed 401 response messages to the SIP interface unit 13. The SIP interface unit 13 transmits the 401 response messages to the SIP interface unit 33 of the client apparatus 3b-1 through the LAN 100 (i25 in FIG. 16).

The SIP interface unit 33 of the client apparatus 3b-1 which receives the 401 response messages added with the Challenge, the inverse Digest, and the presence/absence data of encoding of the mutual authentication password confirms the normality of formats or the like of the 401 response messages. When the 401 response messages are normal, the SIP interface unit 33 transfers the 401 response messages to the SIP message analyzing unit 37. When the received messages are the 401 response messages added with the Challenge, the inverse Digest, and the presence/absence data of encoding of the mutual authentication password, the SIP message analyzing unit 37 notifies the client authentication unit 34 of the Challenge data, notifies the server authentication unit 35 of the inverse Digest data, and notifies the encoding information setting unit 39 of the presence/absence data of encoding of the mutual authentication password.

The server authentication unit 35 authenticates the received inverse Digest (server authentication) (i34 in FIG. 16). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement and designates the SIP message forming unit 36 to form a REGISTER message added with the Digest.

The client authentication unit 34 designates the encoding information setting unit 39 to generate a mutual authentication password delivery encoding key used when a mutual authentication password is encoded and transmitted when a mutual authentication password used in mutual authentication in the second and subsequent REGISTER states is delivered. The encoding information setting unit 39 which is designated to generate the mutual authentication password delivery encoding key stores the presence/absence data of encoding of the mutual authentication password (i35 in FIG. 16). When the presence/absence data of encoding of the mutual authentication password is the presence data of encoding of the mutual authentication password, the encoding information setting unit 39 generates and stores the mutual authentication password delivery encoding key (i36 in FIG. 16).

The SIP message forming unit 36 transfers the formed REGISTER message to the SIP interface unit 33. The SIP interface unit 33 transmits the REGISTER message to the SIP interface unit 13 of the server apparatus 1d through the LAN 100 (i37 in FIG. 17).

The SIP interface unit 13 of the server apparatus 1d which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (i26 in FIG. 17). When the Digest is authenticated, the client authentication unit 14 completes the authentication of the client apparatus 3b-1 and permits an operation of the client apparatus 3b-1 in the SIP-protocol-coping client-server distributed system including the server apparatus 1d.

The client authentication unit 14 designates a mutual authentication password forming unit 18 to form a mutual authentication password used in second and subsequent start-up states of the client apparatus 3b-1. The mutual authentication password forming unit 18 forms a random mutual authentication password, and notifies the client authentication unit 14 of the formed mutual authentication password. The client authentication unit 14 notifies the user name/password setting unit 11 of the mutual authentication password and designates the user name/password setting unit 11 to set the mutual authentication password. The user name/password setting unit 11 stores the mutual authentication password (i27 in FIG. 17).

Furthermore, the client authentication unit 14 designates the mutual authentication password encoding unit 19 to encode the formed mutual authentication password. The mutual authentication password encoding unit 19 asks the encoding information setting unit 20 about an encoding rule and a mutual authentication password delivery encoding key, encodes the mutual authentication password formed by the mutual authentication password forming unit 18 by using the read encoding rule and the read mutual authentication password delivery encoding key, and notifies the client authentication unit 14 of the encoded mutual authentication password (i28 in FIG. 17).

The client authentication unit 14 designates the SIP message forming unit 16 to form a 200 response message added with an encoded mutual authentication password (200 OK). The SIP message forming unit 16 transfers the formed 200 response message to the SIP interface unit 13. The SIP interface unit 13 transmits the 200 response message to the SIP interface unit 33 of the client apparatus 3b-1 through the LAN 100 (i29 in FIG. 17).

The client authentication unit 14 designates a user name/password setting unit 11 to make the one-time password invalid. The user name/password setting unit 11 designated to make the one-time password invalid makes the stored one-time password invalid (i30 in FIG. 17).

The SIP interface unit 33 of the client apparatus 3b-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception and the encoded mutual authentication password.

The client authentication unit 34 recognizes client authentication achievement in response to the client authentication achievement response reception notification and starts an operation of the client apparatus 3b-1 in the SIP-protocol-coping client-server distributed system including the server apparatus 1d (i50 in FIG. 17).

The client authentication unit 34 designates the mutual authentication password decoding unit 38 to decode the received mutual authentication password. The mutual authentication password decoding unit 38 asks the encoding information setting unit 39 about an encoding rule and an authentication password delivery encoding key, decodes the mutual authentication password received from the server apparatus 1d by using the read encoding rule and the read mutual authentication password delivery encoding key, and notifies the client authentication unit 34 of the decoded mutual authentication password (i38 in FIG. 17).

The client authentication unit 34 notifies the user name/password setting unit 31 of the decoded mutual authentication password and designates the user name/password setting unit 31 to set the mutual authentication password. The user name/password setting unit 31 designed to set the mutual authentication password stores the mutual authentication password (i39 in FIG. 17).

Furthermore, the client authentication unit 34 designates the user name/password setting unit 31 to make the one-time password invalid. The user name/password setting unit 31 designated to make the one-time password invalid makes the stored one-time password invalid (i40 in FIG. 17).

In this manner, in the embodiment, in addition to the effect in the eighth embodiment of the present invention, the function of selecting the presence/absence of encoding is given to make it possible to secure compatibility with the client apparatus 3b-1 which has no encoding function. Although the operations of client apparatuses 3b-2 and 3b-3 are not described above, the same effect as that obtained when the client apparatus 3b-1 is used can be obtained.

### Tenth Embodiment

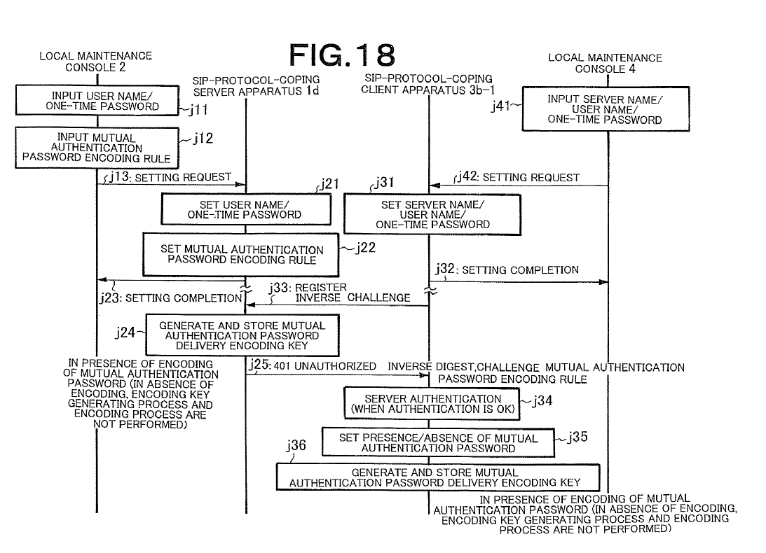

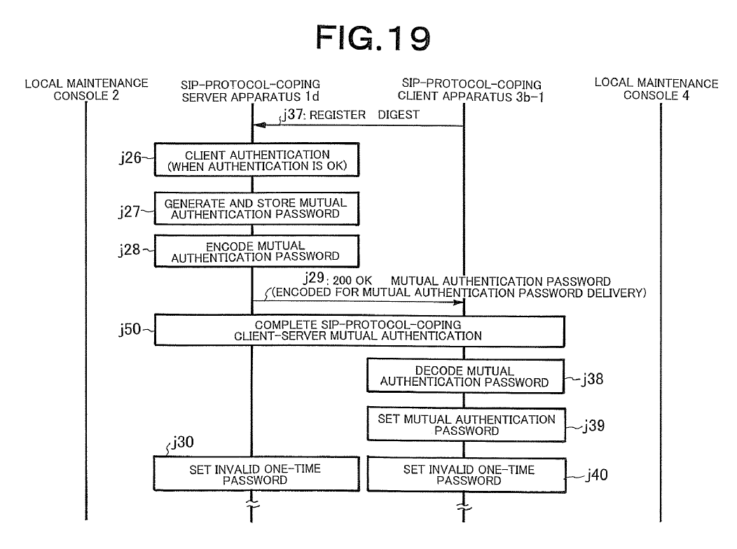

FIGS. 18 and 19 are sequence charts showing an operation of the SIP-protocol-coping client-server distributed system according to a tenth embodiment of the present invention. The client-server distributed system according to the tenth embodiment of the present invention has the same configuration as that of the client-server distributed system according to the ninth embodiment of the present invention shown in FIG. 15, the same reference numerals as in the ninth embodiment denote the same parts in the tenth embodiment. The operation of the client-server distributed system according to the tenth embodiment of the present invention will be described below with reference to FIGS. 15, 18, and 19. Processes of the server apparatus 1d and processes of the client apparatus 3b-1 shown in FIGS. 18 and 19 are realized such that programs are executed by CPUs of the server apparatus 1d and the client apparatus 3b-1.

When a user name and a one-time password of the client apparatus 3b-1 and an encoding rule of a mutual authentication password are input from a local maintenance console 2 connected to the server apparatus 1d in advance (j11 in FIG. 18), a user name/password input interface unit 12 receives a setting request including the user name/one-time password data (j12 in FIG. 18). When the normality of the user name and the one-time password can be confirmed, the user name/password input interface unit 12 communicates the user name and the one-time password to the user name/password setting unit 11. The user name/password setting unit 11 stores the user name and the one-time password (j21 in FIG. 18).

The encoding information input interface unit 21 receives a setting request including the encoding rule data of the mutual authentication password. When the normality of the encoding rule data of the mutual authentication password can be confirmed, the encoding information input interface unit 21 communicates the encoding rule data of the mutual authentication password to the encoding information setting unit 20. The encoding information setting unit 20 stores the encoding rule data of the mutual authentication password (j22 in FIG. 18). Thereafter, the user name/password setting unit 11 transmits setting completion from the user name/password input interface unit 12 to the local maintenance console 2 (j23 in FIG. 18).

When a server name of the server apparatus 1d and a user name and a one-time password of the client apparatus 3b-1 are input from the local maintenance console 4 connected to the client apparatus 3b-1 in advance (j41 in FIG. 18), the server name/user name/password input interface unit 32 receives a setting request including the server name/user name/one-time password data (j42 in FIG. 18). When the normality of the server name, the user name, and the one-time password can be confirmed, the server name/user name/password input interface unit 32 communicates the server name, the user name, and the one-time password to the user name/password setting unit 31. The user name/password setting unit 31 stores the server name, the user name, and the one-time password (j31 in FIG. 18), and setting completion is transmitted from the server name/user name/password input interface unit 32 to the local maintenance console 4 (j32 in FIG. 18). In this case, the user name and the mutual authentication password input to the server apparatus 1d and the client apparatus 3b-1 are values (same values) shared by the server apparatus 1d and the client apparatus 3b-1.

After the server name, the user name, and the one-time password are set in the user name/password setting unit 31, when the client apparatus 3b-1 is started up, the server authentication unit 35 forms an inverse Challenge, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1d through the LAN 100 (j33 in FIG. 18).

The SIP interface unit 13 of the server apparatus 1d which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3b-1 and notifies a server authentication unit 15 of the inverse Challenge data.

The client authentication unit 14 which is designated to start the authentication of the client apparatus 3b-1 forms a Challenge, designates an SIP message forming unit 16 to form a 401 response message (401 Unauthorized) added with the Challenge, and stores the Challenge. The client authentication unit 14 designates the encoding information setting unit 20 to generate a mutual authentication password delivery encoding key used when the mutual authentication password is encoded and transmitted when the mutual authentication password used in mutual authentication in the second and subsequent REGISTER states is delivered. The encoding information setting unit 20 generates and stores the mutual authentication password delivery encoding key (j24 in FIG. 18).

At the same time, the server authentication unit 15 forms an inverse Digest and designates the SIP message forming unit 16 to form 401 response messages added with the inverse Digest and the encoding rule data of the mutual authentication password. The SIP message forming unit 16 forms 401 response messages added with the Challenge, the inverse Digest, and the encoding rule data of the mutual authentication password and transfers the formed 401 response messages to the SIP interface unit 13. The SIP interface unit 13 transmits the 401 response messages to the SIP interface unit 33 of the client apparatus 3b-1 through the LAN 100 (j24 in FIG. 18).

The SIP interface unit 33 of the client apparatus 3b-1 which receives the 401 response messages added with the Challenge, the inverse Digest, and the encoding rule data of the mutual authentication password confirms the normality of formats or the like of the 401 response messages. When the 401 response messages are normal, the SIP interface unit 33 transfers the 401 response messages to the SIP message analyzing unit 37. When the received messages are the 401 response messages added with the Challenge, the inverse Digest, and the encoding rule data of the mutual authentication password, the SIP message analyzing unit 37 notifies the client authentication unit 34 of the Challenge data, notifies the server authentication unit 35 of the inverse Digest data, and notifies an encoding information setting unit 39 of the mutual authentication password encoding rule data.

The server authentication unit 35 authenticates the received inverse Digest (server authentication) (j34 in FIG. 18). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement and designates the SIP message forming unit 36 to form a REGISTER message added with the Digest.

The client authentication unit 34 designates the encoding information setting unit 39 to generate a mutual authentication password delivery encoding key used when a mutual authentication password is encoded and transmitted when a mutual authentication password used in mutual authentication in the second and subsequent REGISTER states is delivered. The designated encoding information setting unit 39 stores the encoding rule data of the transmitted mutual authentication password (j36 in FIG. 18).

The SIP message forming unit 36 transfers the formed REGISTER message to the SIP interface unit 33. The SIP interface unit 33 transmits the REGISTER message to the SIP interface unit 13 of the server apparatus 1d through the LAN 100 (j37 in FIG. 19).

The SIP interface unit 13 of the server apparatus 1d which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (j26 in FIG. 19). When the Digest is authenticated, the client authentication unit 14 completes the authentication of the client apparatus 3b-1 and permits an operation of the client apparatus 3b-1 in the SIP-protocol-coping client-server distributed system including the server apparatus 1d.

The client authentication unit 14 designates a mutual authentication password forming unit 18 to form a mutual authentication password used in second and subsequent start-up states of the client apparatus 3b-1. The mutual authentication password forming unit 18 forms a random mutual authentication password, and notifies the client authentication unit 14 of the formed mutual authentication password. The client authentication unit 14 notifies the user name/password setting unit 11 of the mutual authentication password and designates the user name/password setting unit 11 to set the mutual authentication password. The user name/password setting unit 11 stores the mutual authentication password (j27 in FIG. 19).

Furthermore, the client authentication unit 14 designates the mutual authentication password encoding unit 19 to encode the formed mutual authentication password. The mutual authentication password encoding unit 19 asks the encoding information setting unit 20 about an encoding rule and a mutual authentication password delivery encoding key, encodes the mutual authentication password formed by using the read encoding rule and the read mutual authentication password delivery encoding key, and notifies the client authentication unit 14 of the encoded mutual authentication password (j28 in FIG. 19).

The client authentication unit 14 designates the SIP message forming unit 16 to form a 200 response message added with an encoded mutual authentication password (200 OK). The SIP message forming unit 16 transfers the formed 200 response message to the SIP interface unit 13. The SIP interface unit 13 transmits the 200 response message to the SIP interface unit 33 of the client apparatus 3b-1 through the LAN 100 (j29 in FIG. 18).

The client authentication unit 14 designates a user name/password setting unit 11 to make the one-time password invalid. The user name/password setting unit 11 designated to make the one-time password invalid makes the stored one-time password invalid (j30 in FIG. 18).

The SIP interface unit 33 of the client apparatus 3b-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception and the encoded mutual authentication password. The client authentication unit 34 recognizes client authentication achievement in response to the client authentication achievement response reception notification and starts an operation of the client apparatus 3b-1 in the SIP-protocol-coping client-server distributed system including the server apparatus 1d.

The client authentication unit 34 designates the mutual authentication password decoding unit 38 to decode the received mutual authentication password. The mutual authentication password decoding unit 38 asks the encoding information setting unit 39 about an encoding rule and an authentication password delivery encoding key, decodes the mutual authentication password received by using the read encoding rule and the read mutual authentication password delivery encoding key, and notifies the client authentication unit 34 of the decoded mutual authentication password (j38 in FIG. 19).

The client authentication unit 34 notifies the user name/password setting unit 31 of the decoded mutual authentication password and designates the user name/password setting unit 31 to set the mutual authentication password. The user name/password setting unit 31 designed to set the mutual authentication password stores the mutual authentication password (j39 in FIG. 19). Furthermore, the client authentication unit 34 designates the user name/password setting unit 31 to make the one-time password invalid. The user name/password setting unit 31 designated to make the one-time password invalid makes the stored one-time password invalid (j40 in FIG. 19).

In this manner, in the embodiment, in addition to the effect in the eighth embodiment of the present invention, the function of selecting the encoding rule is given to make it possible to use the latest encoding rule without requiring additional development of an interface for selecting an encoding rule when an operable encoding rule will be added in the future. The security can be reinforced. Although the operations of client apparatuses 3b-2 and 3b-3 are not described above, the same effect as that obtained when the client apparatus 3b-1 is used can be obtained.

### Eleventh Embodiment

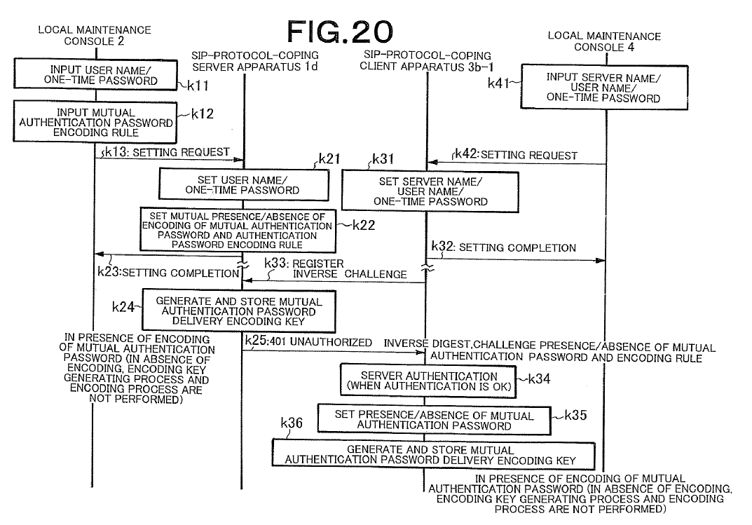

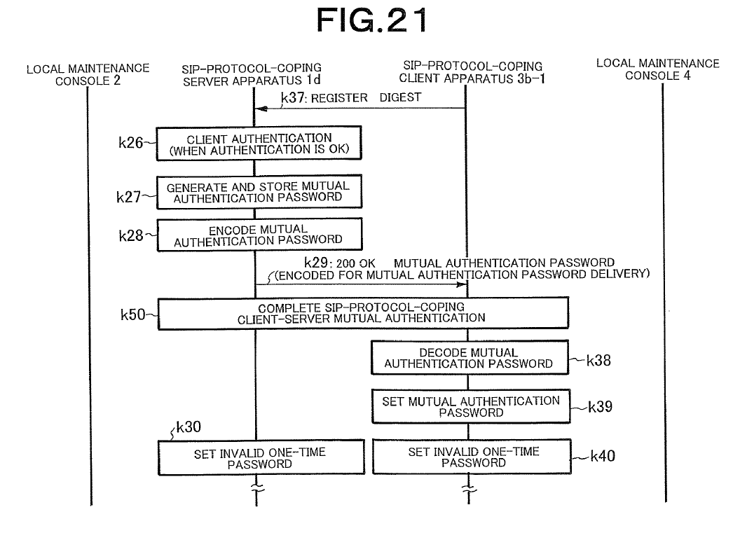

FIGS. 20 and 21 are sequence charts showing an operation of the SIP-protocol-coping client-server distributed system according to an eleventh embodiment of the present invention. The client-server distributed system according to the eleventh embodiment of the present invention has the same configuration as that of the client-server distributed system according to the ninth embodiment of the present invention shown in FIG. 15, a description of the configuration will be omitted. The operation of the client-server distributed system according to the eleventh embodiment of the present invention will be described below with reference to FIGS. 15, 20, and 21. Processes of the server apparatus 1d and processes of the client apparatus 3b-1 shown in FIGS. 20 and 21 are realized such that programs are executed by CPUs of the server apparatus 1d and the client apparatus 3b-1.

When a user name and a one-time password of the client apparatus 3b-1, the presence/absence of encoding of a mutual authentication password, and an encoding rule of the mutual authentication password are input from a local maintenance console 2 connected to the server apparatus 1d in advance (k11 in FIG. 20), a user name/password input interface unit 12 receives a setting request including the user name/one-time password data (k12 in FIG. 20). When the normality of the user name and the one-time password can be confirmed, the user name/password input interface unit 12 communicates the user name and the one-time password to the user name/password setting unit 11. The user name/password setting unit 11 stores the user name and the one-time password (k21 in FIG. 20).

The encoding information input interface unit 21 receives a setting request including the presence/absence of encoding and the encoding rule data of the mutual authentication password. When the normality of the presence/absence of encoding and the encoding rule data of the mutual authentication password can be confirmed, the encoding information input interface unit 21 communicates the presence/absence of encoding and the encoding rule data of the mutual authentication password to the encoding information setting unit 20. The encoding information setting unit 20 stores the presence/absence of encoding and the encoding rule data of the mutual authentication password (k22 in FIG. 20). Thereafter, the user name/password setting unit 11 transmits setting completion from the user name/password input interface unit 12 to the local maintenance console 2 (k23 in FIG. 20).

When a server name of the server apparatus 1d and a user name and a one-time password of the client apparatus 3b-1 are input from the local maintenance console 4 connected to the client apparatus 3b-1 in advance (k41 in FIG. 20), the server name/user name/password input interface unit 32 receives a setting request including the server name/user name/one-time password data (k42 in FIG. 20). When the normality of the server name, the user name, and the one-time password can be confirmed, the server name/user name/password input interface unit 32 communicates the server name, the user name, and the one-time password to the user name/password setting unit 31. The user name/password setting unit 31 stores the server name, the user name, and the one-time password (k31 in FIG. 20), and setting completion is transmitted from the server name/user name/password input interface unit 32 to the local maintenance console 4 (k32 in FIG. 20). In this case, the user name and the one-time password input to the server apparatus 1d and the client apparatus 3b-1 are values (same values) shared by the server apparatus 1d and the client apparatus 3b-1.

After the server name, the user name, and the one-time password are set in the user name/password setting unit 31, when the client apparatus 3b-1 is started up, the server authentication unit 35 forms an inverse Challenge, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1d through the LAN 100 (k33 in FIG. 20).

The SIP interface unit 13 of the server apparatus 1d which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3b-1 and notifies a server authentication unit 15 of the inverse Challenge data.

The client authentication unit 14 which is designated to start the authentication of the client apparatus 3b-1 forms a Challenge, designates an SIP message forming unit 16 to form a 401 response message (401 Unauthorized) added with the Challenge, and stores the Challenge. The client authentication unit 14 asks the encoding information setting unit 20 whether the mutual authentication password is encoded and transmitted when the mutual authentication password used in mutual authentication in the second and subsequent REGISTER states is delivered, and designates the encoding information setting unit 20 to generate a mutual authentication password delivery encoding key when the encoding is present. The encoding information setting unit 20 generates and stores the mutual authentication password delivery encoding key (k24 in FIG. 20).

At the same time, the server authentication unit 15 forms an inverse Digest and designates the SIP message forming unit 16 to form 401 response messages added with the inverse Digest and the presence/absence of encoding and the encoding rule data of the mutual authentication password. The SIP message forming unit 16 forms 401 response messages added with the Challenge, the inverse Digest, and the presence/absence of encoding and the encoding rule data of the mutual authentication password and transfers the formed 401 response messages to the SIP interface unit 13. The SIP interface unit 13 transmits the 401 response messages to the SIP interface unit 33 of the client apparatus 3b-1 through the LAN 100 (k25 in FIG. 20).

The SIP interface unit 33 of the client apparatus 3b-1 which receives the 401 response messages added with the Challenge, the inverse Digest, and the presence/absence of encoding and the encoding rule data of the mutual authentication password confirms the normality of formats or the like of the 401 response messages. When the 401 response messages are normal, the SIP interface unit 33 transfers the 401 response messages to the SIP message analyzing unit 37. When the received messages are the 401 response messages added with the Challenge, the inverse Digest, and the presence/absence of encoding and the encoding rule data of the mutual authentication password, the SIP message analyzing unit 37 notifies the client authentication unit 34 of the Challenge data, notifies the server authentication unit 35 of the inverse Digest data, and notifies an encoding information setting unit 39 of the presence/absence of encoding and the encoding rule data of the mutual authentication password.

The server authentication unit 35 authenticates the received inverse Digest (server authentication) (k34 in FIG. 20). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement and designates the SIP message forming unit 36 to form a REGISTER message added with the Digest.

The client authentication unit 34 designates the encoding information setting unit 39 to generate a mutual authentication password delivery encoding key used when a mutual authentication password is encoded and transmitted when a mutual authentication password used in mutual authentication in the second and subsequent REGISTER states is delivered. The designated encoding information setting unit 39 stores the presence/absence of encoding and the encoding rule data of the transmitted mutual authentication password (k35 in FIG. 20). When the presence/absence data of encoding of the mutual authentication password is the presence of encoding of the mutual authentication password, the encoding information setting unit 39 generates and stores the mutual authentication password delivery encoding key (k36 in FIG. 20).

The SIP message forming unit 36 transfers the formed REGISTER message to the SIP interface unit 33. The SIP interface unit 33 transmits the REGISTER message to the SIP interface unit 13 of the server apparatus 1d through the LAN 100 (k37 in FIG. 21).

The SIP interface unit 13 of the server apparatus 1d which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (k26 in FIG. 21). When the Digest is authenticated, the client authentication unit 14 completes the authentication of the client apparatus 3b-1 and permits an operation of the client apparatus 3b-1 in the SIP-protocol-coping client-server distributed system including the server apparatus 1d.

The client authentication unit 14 designates a mutual authentication password forming unit 18 to form a mutual authentication password used in second and subsequent start-up states of the client apparatus 3b-1. The mutual authentication password forming unit 18 forms a random mutual authentication password, and notifies the client authentication unit 14 of the formed mutual authentication password. The client authentication unit 14 notifies the user name/password setting unit 11 of the mutual authentication password and designates the user name/password setting unit 11 to set the mutual authentication password. The user name/password setting unit 11 stores the mutual authentication password (k27 in FIG. 21).

Furthermore, the client authentication unit 14 designates the mutual authentication password encoding unit 19 to encode the formed mutual authentication password. The mutual authentication password encoding unit 19 asks the encoding information setting unit 20 about an encoding rule and a mutual authentication password delivery encoding key, encodes the mutual authentication password formed by the mutual authentication password forming unit 18 by using the read encoding rule and the read mutual authentication password delivery encoding key, and notifies the client authentication unit 14 of the encoded mutual authentication password (k28 in FIG. 21).

The client authentication unit 14 designates the SIP message forming unit 16 to form a 200 response message added with an encoded mutual authentication password (200 OK). The SIP message forming unit 16 transfers the formed 200 response message to the SIP interface unit 13. The SIP interface unit 13 transmits the 200 response message to the SIP interface unit 33 of the client apparatus 3b-1 through the LAN 100 (k29 in FIG. 21).

The client authentication unit 14 designates a user name/password setting unit 11 to make the one-time password invalid. The user name/password setting unit 11 designated to make the one-time password invalid makes the stored one-time password invalid (k30 in FIG. 21).

The SIP interface unit 33 of the client apparatus 3b-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception and the encoded mutual authentication password.

The client authentication unit 34 recognizes client authentication achievement in response to the client authentication achievement response reception notification and starts an operation of the client apparatus 3b-1 in the SIP-protocol-coping client-server distributed system including the server apparatus 1d (k50 in FIG. 21).

The client authentication unit 34 designates the mutual authentication password decoding unit 38 to decode the received mutual authentication password. The mutual authentication password decoding unit 38 asks the encoding information setting unit 39 about an encoding rule and an authentication password delivery encoding key, decodes the mutual authentication password received by using the read encoding rule and the read mutual authentication password delivery encoding key, and notifies the client authentication unit 34 of the decoded mutual authentication password (k38 in FIG. 21).

The client authentication unit 34 notifies the user name/password setting unit 31 of the decoded mutual authentication password and designates the user name/password setting unit 31 to set the mutual authentication password. The user name/password setting unit 31 designed to set the mutual authentication password stores the mutual authentication password (k39 in FIG. 21). Furthermore, the client authentication unit 34 designates the user name/password setting unit 31 to make the one-time password invalid. The user name/password setting unit 31 designated to make the one-time password invalid makes the stored one-time password invalid (k40 in FIG. 21).

In this manner, in the embodiment, in addition to the effect in the eighth embodiment of the present invention, the function of selecting the presence/absence of encoding to make it possible to secure compatibility with the client apparatus 3b-1 which has no encoding function, and the function of selecting the encoding rule is given to make it possible to use the latest encoding rule without requiring additional development of an interface for selecting an encoding rule when an operable encoding rule will be added in the future. The security can be reinforced. Although the operations of client apparatuses 3b-2 and 3b-3 are not described above, the same effect as that obtained when the client apparatus 3b-1 is used can be obtained.

### Twelfth Embodiment

An SIP-protocol-coping client-server distributed system according to a twelfth embodiment of the present invention has the same configuration as that of the SIP-protocol-coping client-server distributed system according to the eighth embodiment of the present invention shown in FIG. 12 and has the same operation as that of the SIP-protocol-coping client-server distributed system according to the eighth embodiment of the present invention shown in FIGS. 13 and 14. However, the client-server distributed system according to the twelfth embodiment of the present invention is different from the client-server distributed system according to the eighth embodiment of the present invention in that an encoding key common in a server apparatus 2c and client apparatuses 3b-1 to 3b-3 is generated.

The operation of the client-server distributed system according to the twelfth embodiment of the present invention will be described below with reference to FIGS. 12 to 14. Processes of the server apparatus 2c and processes of the client apparatus 3b-1 are realized such that programs are executed by CPUs of the server apparatus 1c and the client apparatus 3b-1.

When a user name and a one-time password of the client apparatus 3b-1 are input from a local maintenance console 2 connected to the server apparatus 1c in advance (h11 in FIG. 13), a user name/password input interface unit 12 receives a setting request including the user name/one-time password data (h12 in FIG. 13). When the normality of the user name and the one-time password can be confirmed, the user name/password input interface unit 12 communicates the user name and the one-time password to the user name/password setting unit 11. The user name/password setting unit 11 stores the user name and the one-time password (h21 in FIG. 13), and setting completion is transmitted from the user name/password input interface unit 12 to the local maintenance console 2 (h22 in FIG. 13).

When a server name of the server apparatus 1c and a user name and a one-time password of the client apparatus 3b-1 are input from the local maintenance console 4 connected to the client apparatus 3b-1 in advance (h41 in FIG. 13), the server name/user name/password input interface unit 32 receives a setting request including the server name/user name/one-time password data (h42 in FIG. 13). When the normality of the server name, the user name, and the one-time password can be confirmed, the server name/user name/password input interface unit 32 communicates the server name, the user name, and the one-time password to the user name/password setting unit 31. The user name/password setting unit 31 stores the server name, the user name, and the one-time password (h31 in FIG. 13), and setting completion is transmitted from the server name/user name/password input interface unit 32 to the local maintenance console 4 (h32 in FIG. 13). In this case, the user name and the one-time password input to the server apparatus 1c and the client apparatus 3b-1 are values (same values) shared by the server apparatus 1c and the client apparatus 3b-1.

After the server name, the user name, and the one-time password are set in the user name/password setting unit 31, when the client apparatus 3b-1 is started up (h33 in FIG. 13), the server authentication unit 35 forms an inverse Challenge, designates the SIP message forming unit 36 to form a REGISTER message added with the inverse Challenge, and stores the inverse Challenge. The SIP message forming unit 36 transfers the formed REGISTER message to the SIP interface unit 33. The SIP interface unit 33 transmits the REGISTER message to the SIP interface unit 13 of the server apparatus 1c through the LAN 100 (h34 in FIG. 13).

The SIP interface unit 13 of the server apparatus 1c which receives the REGISTER message added with the inverse Challenge confirms the normality of a format or the like of the REGISTER message. When the REGISTER message is normal, the SIP interface unit 13 transfers the REGISTER message to the SIP message analyzing unit 17. When the received message is the REGISTER message added with the inverse Challenge, the SIP message analyzing unit 17 designates a client authentication unit 14 to start authentication of the client apparatus 3b-1 and notifies a server authentication unit 15 of the inverse Challenge data.

The client authentication unit 14 which is designated to start the authentication of the client apparatus 3b-1 forms a Challenge, designates an SIP message forming unit 16 to form a 401 response message (401 Unauthorized) added with the Challenge, and stores the Challenge. The client authentication unit 14 designates the encoding information setting unit 20 to generate a mutual authentication password delivery encoding key used when a mutual authentication password is encoded and transmitted when the mutual authentication password used in mutual authentication in the second and subsequent REGISTER states is delivered. The encoding information setting unit 20 generates and stores the mutual authentication password delivery encoding key (h23 in FIG. 13). In this case, the data encoded by the generated mutual authentication password delivery encoding key can be decoded by the mutual authentication password delivery encoding key generated by the encoding information setting unit 39 of the client apparatus 3b-1.

At the same time, the server authentication unit 15 forms an inverse Digest and designates the SIP message forming unit 16 to form a 401 response message added with the inverse Digest. The SIP message forming unit 16 forms 401 response messages added with the Challenge and the inverse Digest and transfers the formed 401 response messages to the SIP interface unit 13. The SIP interface unit 13 transmits the 401 response messages to the SIP interface unit 33 of the client apparatus 3b-1 through the LAN 100 (h24 in FIG. 13).

The SIP interface unit 33 of the client apparatus 3b-1 which receives the 401 response messages added with the Challenge and the inverse Digest confirms the normality of formats or the like of the 401 response messages. When the 401 response messages are normal, the SIP interface unit 33 transfers the 401 response messages to the SIP message analyzing unit 37. When the received messages are the 401 response messages added with the Challenge and the inverse Digest, the SIP message analyzing unit 37 notifies the client authentication unit 34 of the Challenge data and notifies the server authentication unit 35 of the inverse Digest data.

The server authentication unit 35 authenticates the received inverse Digest (server authentication) (h35 in FIG. 13). When the inverse Digest is authenticated, the server authentication unit 35 notifies the client authentication unit 34 of server authentication achievement. The client authentication unit 34 which receives a notification of the server authentication achievement and a notification of the Challenge data recognizes server authentication achievement and designates the SIP message forming unit 36 to form a REGISTER message added with the Digest.

The client authentication unit 34 designates the encoding information setting unit 39 to generate a mutual authentication password delivery encoding key used when a mutual authentication password is encoded and transmitted when a mutual authentication password used in mutual authentication in the second and subsequent REGISTER states is delivered. The encoding information setting unit 39 generates and stores the mutual authentication password delivery encoding key (h36 in FIG. 13). In this case, the generated mutual authentication password delivery encoding key can decode data encoded by the mutual authentication password delivery encoding key generated by the encoding information setting unit 20 of the server apparatus 1d.

The SIP message forming unit 36 transfers the formed REGISTER message to the SIP interface unit 33. The SIP interface unit 33 transmits the REGISTER message to the SIP interface unit 13 of the server apparatus 1c through the LAN 100 (h37 in FIG. 13).

The SIP interface unit 13 of the server apparatus 1c which receives the REGISTER message added with the Digest confirms the normality of a format or the like of the REGISTER message. When the REGISTER message is normal, the SIP interface unit 13 transfers the REGISTER message to the SIP message analyzing unit 17. When the received message is the REGISTER message added with the Digest, the SIP message analyzing unit 17 notifies the client authentication unit 14 of the Digest data.

The client authentication unit 14 authenticates the received Digest (client authentication) (h25 in FIG. 13). When the Digest is authenticated, the client authentication unit 14 completes the authentication of the client apparatus 3b-1 and permits an operation of the client apparatus 3b-1 in the SIP-protocol-coping client-server distributed system including the server apparatus 1c.

The client authentication unit 14 designates a mutual authentication password forming unit 18 to form a mutual authentication password used in second and subsequent start-up states of the client apparatus 3b-1. The mutual authentication password forming unit 18 forms a random mutual authentication password, and notifies the client authentication unit 14 of the formed mutual authentication password. The client authentication unit 14 notifies the user name/password setting unit 11 of the mutual authentication password and designates the user name/password setting unit 11 to set the mutual authentication password. The user name/password setting unit 11 stores the mutual authentication password (h26 in FIG. 14).

The client authentication unit 14 designates the mutual authentication password encoding unit 19 to encode the formed mutual authentication password. The mutual authentication password encoding unit 19 asks the encoding information setting unit 20 about an encoding rule and a mutual authentication password delivery encoding key, encodes the formed mutual authentication password by the read encoding rule and the read mutual authentication password delivery encoding key, and notifies the client authentication unit 14 of the encoded mutual authentication password (h27 in FIG. 14).

The client authentication unit 14 designates the SIP message forming unit 16 to form a 200 response message added with an encoded mutual authentication password (200 OK). The SIP message forming unit 16 transfers the formed 200 response message to the SIP interface unit 13. The SIP interface unit 13 transmits the 200 response message to the SIP interface unit 33 of the client apparatus 3b-1 through the LAN 100 (h28 in FIG. 14).

The client authentication unit 14 designates a user name/password setting unit 11 to make the one-time password invalid. The user name/password setting unit 11 designated to make the one-time password invalid makes the stored one-time password invalid (h30 in FIG. 14).

The SIP interface unit 33 of the client apparatus 3b-1 which receives the 200 response message confirms the normality of a format or the like of the 200 response message. When the 200 response message is normal, the SIP interface unit 33 transfers the 200 response message to the SIP message analyzing unit 37. When the message received by the SIP message analyzing unit 37 is the 200 response message, the SIP message analyzing unit 37 notifies the client authentication unit 34 of client authentication achievement response reception and the encoded mutual authentication password.

The client authentication unit 34 recognizes client authentication achievement in response to the client authentication achievement response reception notification and starts an operation of the client apparatus 3b-1 in the SIP-protocol-coping client-server distributed system including the server apparatus 1 (h29 in FIG. 14).

The client authentication unit 34 designates the mutual authentication password decoding unit 38 to decode the received mutual authentication password. The mutual authentication password decoding unit 38 asks the encoding information setting unit 39 about an encoding rule and an authentication password delivery encoding key, decodes the mutual authentication password received by the SIP interface unit 33 by the read encoding rule and the read mutual authentication password delivery encoding key, and notifies the client authentication unit 34 of the decoded mutual authentication password (h38 in FIG. 14).

The client authentication unit 34 notifies the user name/password setting unit 31 of the decoded mutual authentication password and designates the user name/password setting unit 31 to set the mutual authentication password. The user name/password setting unit 31 designed to set the mutual authentication password stores the mutual authentication password (h39 in FIG. 14). Furthermore, the client authentication unit 34 designates the user name/password setting unit 31 to make the one-time password invalid. The user name/password setting unit 31 designated to make the one-time password invalid makes the stored one-time password invalid (h40 in FIG. 14).

In this manner, in the embodiment, in addition to the effect in the sixth embodiment of the present invention, since the procedures of generating a pair of mutual authentication passwords for the client apparatus 3b-1 and the server apparatus 1d are used not to deliver the mutual authentication password delivery encoding keys through a network, encoding key security in encoding of the mutual authentication passwords can be reinforced. Although the operations of client apparatuses 3b-2, 3b-3 are not described above, the same effect as that obtained when the client apparatus 3b-1 is used can be obtained.

### Thirteenth Embodiment

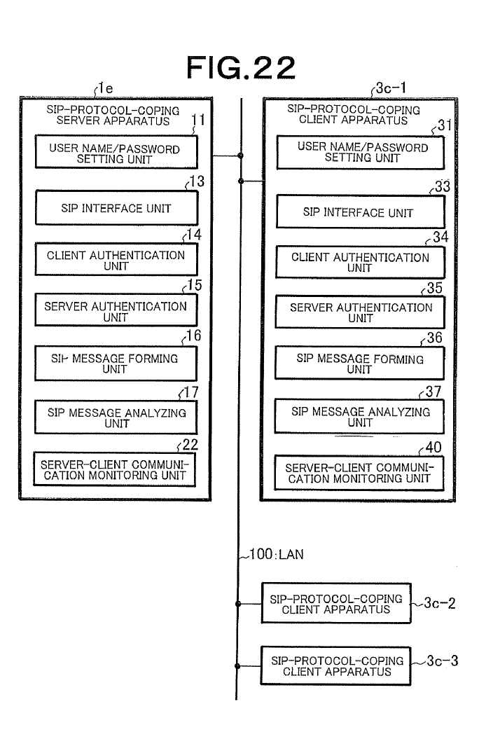

FIG. 22 is a block diagram showing a configuration of an SIP-protocol-coping client-server distributed system according to a thirteenth embodiment of the present invention. In FIG. 22, the client-server distributed system according to the thirteenth embodiment of the present invention has the same configuration as that of the client-server distributed system according to the seventh embodiment of the present invention shown in FIG. 10 except that server-client communication monitoring units 22 and 40 are added to a sever apparatus 1e and client apparatuses 3c-1 to 3c-3, respectively. However, in the thirteenth embodiment of the present invention, when the server-client communication monitoring units 22 and 40 detect that server-client communication is interrupted for a predetermined period of time or longer, client authentication and server authentication are repeated.

The sever apparatus 1e holds mutual authentication states of the client apparatuses 3c-1 to 3c-3 in a REGISTER state in a client authentication unit 14. The client apparatuses 3c-1 to 3c-3 hold a mutual authentication state of the sever apparatus 1e in a REGISTER state in a client authentication unit 34.

In the embodiment, when the above configuration is realized, communication between the sever apparatus 1e and the client apparatuses 3c-1 to 3c-3 can be monitored from the sever apparatus 1e, and mutual authentication between the client and the server in a REGISTER state can be repeated when communication between is interrupted for a predetermined period of time or longer.

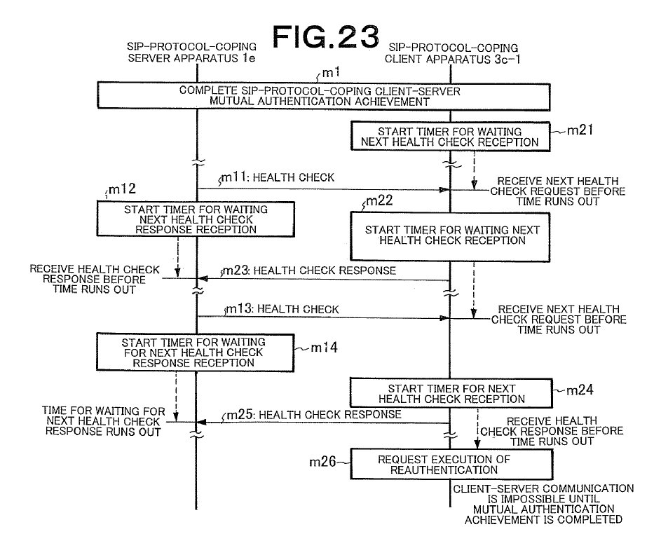

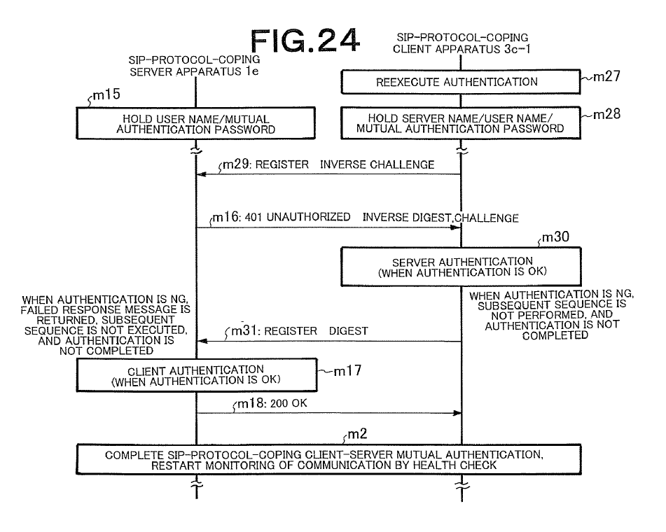

FIGS. 23 and 24 are sequence charts showing an operation of an SIP-protocol-coping client-server distributed system according to the thirteenth embodiment of the present invention. An operation of the client-server distributed system according to the thirteenth embodiment of the present invention will be described below with reference to FIGS. 22 to 24. Processes of the sever apparatus 1e and processes of the client apparatus 3c-1 shown in FIGS. 23 and 24 are realized such that programs are executed by CPUs of the sever apparatus 1e and the client apparatus 3c-1.

When mutual authentication between the sever apparatus 1e and the client apparatus 3c-1 in a REGISTER state between the apparatuses is achieved and completed, a health check command is transmitted from the sever apparatus 1e to the client apparatus 3c-1 at predetermined time intervals. In response to this, a health check response command is transmitted from the client apparatus 3c-1 to monitor client-server communication coping with an SIP protocol.

When mutual authentication between the sever apparatus 1e and the client apparatus 3c-1 in a REGISTER state is achieved and completed (m1 in FIG. 23 the client authentication unit 34 of the client apparatus 3c-1 designates a server-client communication monitoring unit 40 to start monitor of client-server communication. The server-client communication monitoring unit 40 starts a timer for waiting for the next health check reception (m21 in FIG. 23).

Similarly, when the mutual authentication between the sever apparatus 1e and the client apparatus 3c-1 in the REGISTER state is achieved and completed, the client authentication unit 14 of the sever apparatus 1e designates the server-client communication monitoring unit 22 to start monitor of client-server communication. The server-client communication monitoring unit 22 designates an SIP message forming unit 16 to form a NOTIFY (method of returning present state information) message added with health check data. The SIP message forming unit 16 transfers the formed NOTIFY message to the SIP interface unit 13. The SIP interface unit 13 transmits the REGISTER message to an SIP interface unit 33 of the client apparatus 3c-1 through a LAN 100 (m11 in FIG. 23). The server-client communication monitoring unit 22 starts a timer for waiting for a health check response reception (m12 in FIG. 23).

The SIP interface unit 33 of the client apparatus 3c-1 which receives the NOTIFY message added with the health check data confirms normality of a format or the like of the NOTIFY message. When the NOTIFY message is normal, the SIP interface unit 33 transfers the NOTIFY message to the SIP message analyzing unit 37. The received message is a NOTIFY message added with health check data, the SIP message analyzing unit 37 notifies the server-client communication monitoring unit 40 of the health check data.

The server-client communication monitoring unit 40 forms health check response data, and designates the SIP message forming unit 36 to form a NOTIFY message added with the health check response data. The SIP message forming unit 36 transfers the formed NOTIFY message to the SIP interface unit 33. The SIP interface unit 33 transfers the NOTIFY message to the SIP interface unit 13 of the sever apparatus 1e through the LAN 100 (m23 in FIG. 23). The server-client communication monitoring unit 40 resets the timer for waiting for the next health check reception to restart the timer (m22 in FIG. 23).

The SIP interface unit 13 of the sever apparatus 1e which receives the NOTIFY message added with the health check response data confirms the normality of a format or the like of the NOTIFY message. When the NOTIFY message is normal, the SIP interface unit 13 transfers the NOTIFY message to the SIP message analyzing unit 17. When the received message is the NOTIFY message added with the health check response data, the SIP message analyzing unit 17 notifies the server-client communication monitoring unit 22 of the health check response data.

The server-client communication monitoring unit 22 resets the timer for waiting for the health check response reception timer to start a timer for waiting for health check response reception from the client apparatus 3c-1 (m14 in FIG. 23). The server-client communication monitoring unit 22 reexecutes health check to the client apparatus 3c-1 (m13 in FIG. 23) after a predetermined period of time, and repeats transmission/reception of the health check/health check reception.

In this case, when it is recognized by the server-client communication monitoring unit 40 of the client apparatus 3c-1 that the next health check wait time runs out, the server-client communication monitoring unit 40 notifies the client authentication unit 34 of execution of reauthentication, and the client authentication unit 34 changes a mutual authentication state between the client apparatus 3c-1 and the sever apparatus 1e in a REGISTER state into incompletion of authentication. Subsequently, client-server communication including call control is made impossible until reauthentication achievement is completed. The server-client communication monitoring unit 40 requests the server authentication unit 35 to execute reauthentication, and mutual authentication between the SIP-protocol-coping client apparatus and the SIP-protocol-coping server apparatus in a REGISTER state is reexecuted (m26 in FIG. 23).

In the thirteenth embodiment of the present invention, since a reexecuting operation of mutual authentication between an SIP-protocol-coping client apparatus and an SIP-protocol-coping server apparatus in a REGISTER state (m15 to m18 and m27 to m31 in FIG. 24) is the same as the operation in the seventh embodiment of the present invention, a description thereof will be omitted.

In this manner, in this embodiment, in addition to the effect in the seventh embodiment of the present invention, the following effect can be obtained. That is, when it is determined that SIP-protocol-coping client-server apparatus communication is interrupted, since communication between the client apparatus 3c-1 and the sever apparatus 1e is made impossible until mutual authentication in a REGISTER state is achieved and completed, security against spoofing or the like can be reinforced. Although the operations of client apparatuses 3c-2 and 3c-3 are not described above, the same effect as that obtained when the client apparatus 3c-1 is used can be obtained.

### Fourteenth Embodiment

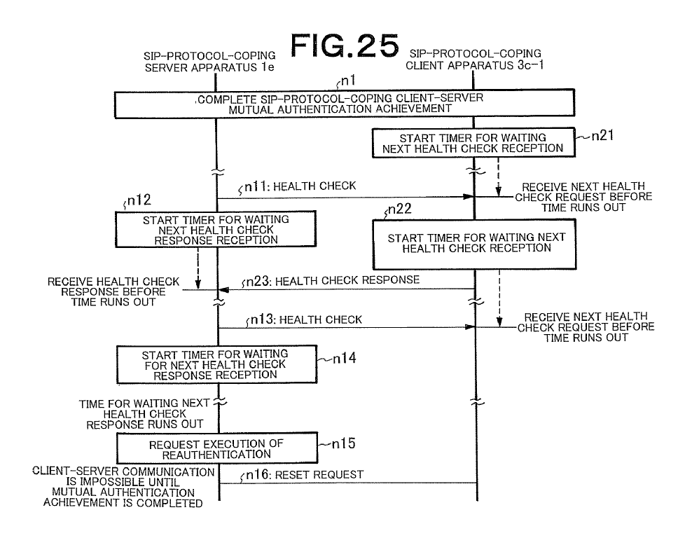

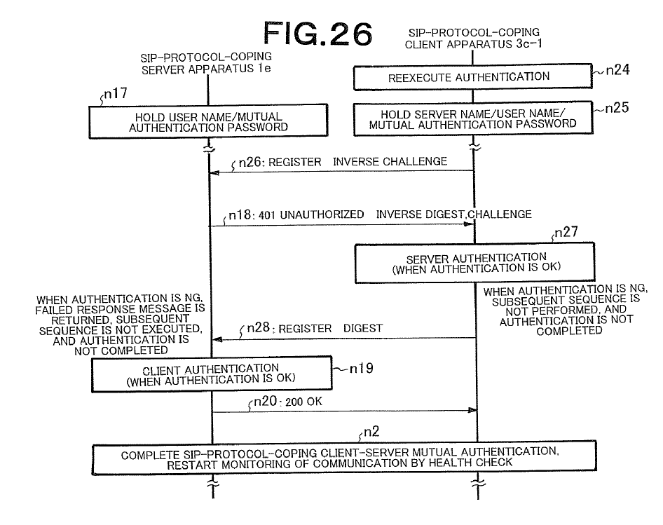

FIGS. 25 and 26 are sequence charts showing an operation of an SIP-protocol-coping client-server distributed system according to a fourteenth embodiment of the present invention. Since the SIP-protocol-coping client-server distributed system according to the fourteenth embodiment of the present invention has the same configuration as that of the client-server distributed system according to the thirteenth embodiment of the present invention shown in FIG. 22, a description thereof will be omitted. An operation of the client-server distributed system according to the fourteenth embodiment of the present invention will be described below with reference to FIGS. 22, 25, and 26. Processes of the sever apparatus 1e and processes of the client apparatus 3c-1 shown in FIGS. 25 and 26 are realized such that programs are executed by CPUs of the sever apparatus 1e and the client apparatus 3c-1.

In the embodiment, when mutual authentication between the sever apparatus 1e and the client apparatus 3c-1 in a REGISTER state is achieved and completed, a health check command is transmitted from the sever apparatus 1e to the client apparatus 3c-1 at predetermined time intervals. In response to this, a health check response command is transmitted from the client apparatus 3c-1 to monitor client-server communication coping with an SIP protocol. Since an operation of monitoring SIP-protocol-coping client-server communication (n11 to n14 and n21 to n23 in FIG. 25) is the same as the operation in the thirteenth embodiment of the present invention shown in FIG. 23, and a description thereof will be omitted.

In this case, when it is recognized by the server-client communication monitoring unit 22 of the sever apparatus 1e that health check response wait time runs out, the server-client communication monitoring unit 22 requests the client authentication unit 14 to execute reauthentication, and the client authentication unit 14 changes a mutual authentication state between the sever apparatus 1e and the client apparatus 3c-1 in a REGISTER state into incompletion of authentication and designates the SIP message forming unit 16 to form a NOTIFY message added with a reset request. The SIP message forming unit 16 transfers the formed NOTIFY message to the SIP interface unit 13. The SIP interface unit 13 transmits the NOTIFY message to the SIP interface unit 33 of the SIP-protocol-coping client apparatus 3c-1 through a LAN 100 (n15 and n16 in FIG. 25). Subsequently, client-server communication including call control is impossible until reauthentication achievement is completed.

In this manner, in the embodiment, mutual authentication between an SIP-protocol-coping client apparatus and an SIP-protocol-coping server apparatus in a REGISTER state is reexecuted. In the embodiment, a reexecuting operation of mutual authentication between an SIP-protocol-coping client apparatus and an SIP-protocol-coping server apparatus in a REGISTER state (n17 to n20, n24 to n28, and n2) is the same as the operation in the seventh embodiment of the present invention, a description thereof will be omitted.

In this manner, in the embodiment, in addition to the effect in the seventh embodiment of the present invention, the following effect can be obtained. That is, when it is determined that SIP-protocol-coping client-server apparatus communication is interrupted, since communication between the client apparatus 3c-1 and the sever apparatus 1e is made impossible until mutual authentication in a REGISTER state is achieved and completed again, security against spoofing or the like can be reinforced. Although the operations of client apparatuses 3c-2 and 3c-3 are not described above, the same effect as that obtained when the client apparatus 3c-1 is used can be obtained.

### Fifteenth Embodiment

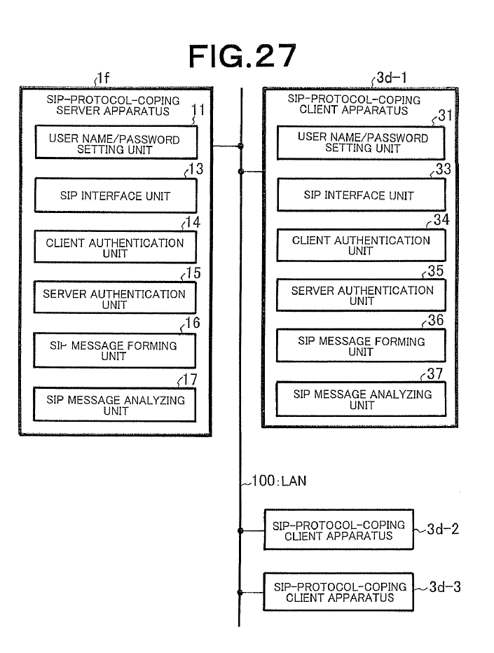

FIG. 27 is a block diagram showing a configuration of an SIP-protocol-coping client-server distributed system according to a fifteenth embodiment of the present invention. In FIG. 27, the client-server distributed system according to the fifteenth embodiment of the present invention has the same configuration as that of the client-server distributed system according to the third embodiment of the present invention shown in FIG. 4 except for a user name/password input interface unit 12 and a local maintenance console 2 in a server apparatus 1f and server name/user name/password input interface unit 32 and a local maintenance console 4 in client apparatuses 3d-1 to 3d-3, and the same reference numerals as in the third embodiment denote the same parts in the fifteenth embodiment. In the fifteenth embodiment of the present invention, client authentication and server authentication are periodically repeated.

The server apparatus 1f holds mutual authentication states of the client apparatuses 3d-1 to 3d-3 in a REGISTER state in a client authentication unit 14. The client apparatuses 3d-1 to 3d-3 hold a mutual authentication state between the client apparatuses 3d-1 to 3d-3 and the sever apparatus 1f in a REGISTER state in a client authentication unit 34.

In the embodiment, the above configuration is realized to make it possible to repeat mutual authentication between the server apparatus 1f and the client apparatuses 3d-1 to 3d-3 in a REGISTER state.

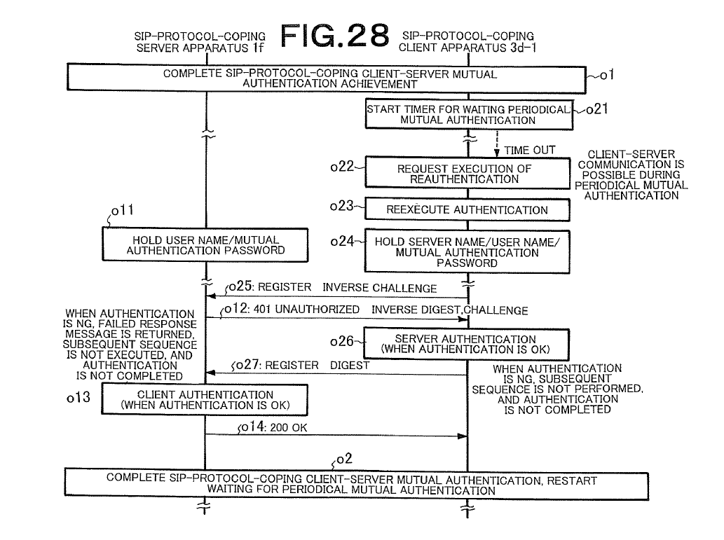

FIG. 28 is a sequence chart showing an operation of the SIP-protocol-coping client-server distributed system according to the fifteenth embodiment of the present invention. An operation of the client-server distributed system according to the fifteenth embodiment of the present invention will be described below with reference to FIG. 28. Processes of the sever apparatus 1f and processes of the client apparatus 3d-1 shown in FIG. 28 are realized such that programs are executed by CPUs of the sever apparatus 1f and the client apparatus 3d-1.

When mutual authentication between the sever apparatus 1f and the client apparatus 3d-1 in a REGISTER state is achieved and completed o1 in FIG. 28), the client authentication unit 34 of the client apparatus 3d-1 starts a timer for waiting for periodical REGISTER state mutual authentication (o21 in FIG. 28).

When time of the timer for waiting for the periodical REGISTER stat mutual authentication runs out, the client authentication unit 34 gives notice of execution of reauthentication to reset the periodical authentication waiting timer, and a REGISTER state mutual authentication state with the server apparatus 1f is changed during execution of periodical authentication (o22 in FIG. 28). Subsequently, client-server communication including call control can be made possible even during reauthentication.

The client authentication unit 34 requests the server authentication unit 35 to execute reauthentication, and mutual authentication between the SIP-protocol-coping client apparatus and the SIP-protocol-coping server apparatus in a REGISTER state is executed (o11 to o14, o23 to o27, and 02 in FIG. 28). In this case, since a reexecuting operation of mutual authentication between the SIP-protocol-coping client apparatus and the SIP-protocol-coping server apparatus in a REGISTER state is the same as that of the seventh embodiment of the present invention, and a description thereof will be omitted.

When the periodical REGISTER state mutual authentication is not achieved, the client authentication unit 34 changes the REGISTER state mutual authentication state between the client apparatus 3d-1 and the server apparatus 1f into incompletion of authentication and executes the REGISTER state mutual authentication. Subsequently, client-server communication including call control is impossible until reauthentication achievement is completed.

In this manner, in the embodiment, in addition to the effect in the seventh embodiment of the present invention, the following effect can be obtained. That is, mutual authentication between an SIP-protocol-coping client apparatus and an SIP-protocol-coping server apparatus is periodically reexecuted to prevent the same authentication state from being held for a long period of time, so that a spoofed client apparatus is prevented from being permitted to perform communication. In addition, in failure of periodical authentication, client-server communication is made impossible until REGISTER state mutual authentication is achieved and completed again. For this reason, security against spoofing or the like can be reinforced.

As described above, in the present invention, in an SIP-protocol-coping client-server distributed system, not only related client authentication from a server apparatus to a client apparatus but also server authentication from the client apparatus to the server apparatus are performed to realize bidirectional authentication, and completion of authentication is recognized by achievement of the bidirectional authentication. An operation of the client apparatus and communication between an SIP-protocol-coping client apparatus and an SIP-protocol-coping server apparatus are made possible, security against spoofing of a server apparatus can be reinforced.

In the present invention, a scheme which reversely defines client authentication is used as a server authentication scheme to make it possible to constitute a client authentication unit and a server authentication unit by a common architecture, and efficiency of apparatus development can be improved.

In the present invention, a one-time password is used as an authentication password manually input by a holder, and the one-time password is made invalid after mutual authentication in a REGISTER state is completed. For this reason, the one-time password can be prevented from artificially flowing out, and security in the SIP-protocol-coping client-server distributed system can be reinforced.

Furthermore, in the present invention, mutual authentication passwords used in second and subsequent authentications between an SIP-protocol-coping client apparatus and an SIP-protocol-coping server apparatus are automatically generated by the server apparatus and delivered to the client apparatus to prevent an erroneous input or a one-time password from artificially flowing out when a password is externally input by a holder, and a password which cannot be presumed can be used by forming a random password. For this reason, security in an SIP-protocol-coping client-server distributed system can be reinforced.

In this case, in the present invention, an authentication password which is manually input by a holder is used as a one-time password, and the password is made invalid after mutual authentication in a REGISTER state is completed to prevent the password from artificially flowing out. Security in the SIP-protocol-coping client-server distributed system can be reinforced.

In the present invention, when a mutual authentication password is delivered from a server apparatus to a client apparatus, encoding of the mutual authentication password is made possible, so that security against leakage of data in notification of a password, intentional hacking, or the like can be reinforced.

In the present invention, as a condition for encoding and delivering a mutual authentication password from a server apparatus to a client apparatus, the presence/absence of encoding and an encoding rule can be externally input from a maintenance console. For this reason, compatibility with the client apparatus which has no encoding function can be secured by a function of selecting the presence/absence of encoding, and the latest encoding rule can be used without additionally developing an interface for selecting an encoding rule when an operable encoding rule will be added in the future. Therefore, security can be reinforced.

Furthermore, in the present invention, a procedure of generating a pair of mutual authentication password delivery encoding keys for an SIP-protocol-coping client apparatus and an SIP-protocol-coping server apparatus is given when a mutual authentication password is encoded and delivered from the server apparatus to the client apparatus, so that the mutual authentication password delivery encoding key is not delivered through a network. For this reason, security of the encoding key in encoding of a mutual authentication password can be reinforced.

In the present invention, when it is determined that communication between an SIP-protocol-coping client apparatus and an SIP-protocol-coping server apparatus is interrupted, the client-server communication is made impossible until mutual authentication in a REGISTER state is achieved and completed again. For this reason, security against spoofing or the like can be reinforced.

In the present invention, mutual authentication between an SIP-protocol-coping client apparatus and an SIP-protocol-coping server apparatus in a REGISTER state is periodically reexecuted to prevent the same authentication state from being held for a long period of time, so that a spoofed client apparatus is prevented from being permitted to perform communication. In addition, in failure of periodical authentication, client-server communication is made impossible until REGISTER state mutual authentication is achieved and completed again. For this reason, security against spoofing or the like can be reinforced.

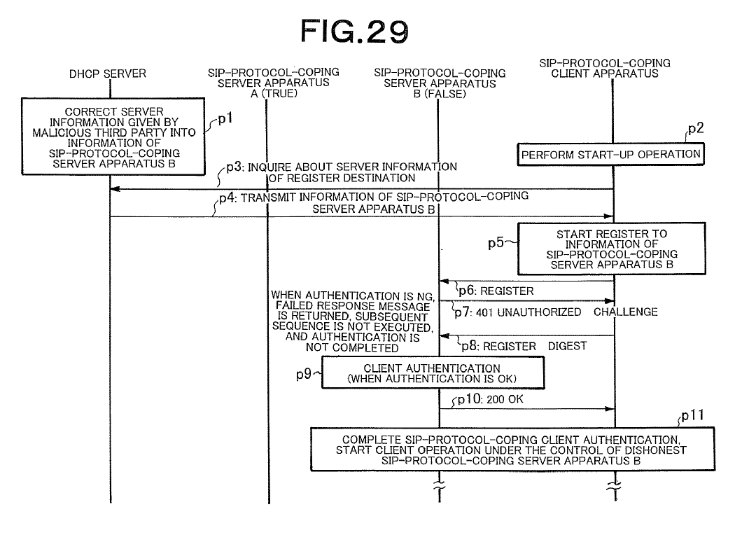

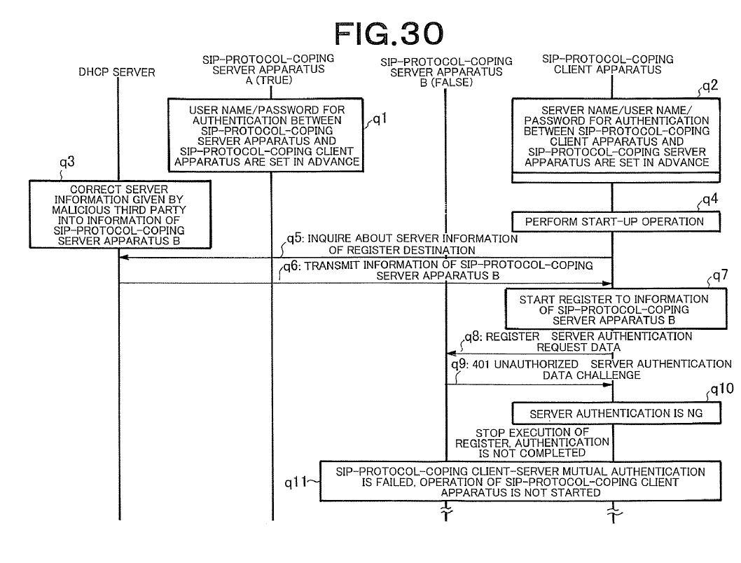

FIGS. 29 and 30 are diagrams for explaining an effect of the present invention. The effect of the present invention will be described below by one example with reference to FIGS. 29 and 30. FIG. 29 shows a spoofing operation of a server apparatus according to a related art, and FIG. 30 shows a spoofing operation of a server apparatus according to the present invention.

FIG. 29, in a start-up state of a client apparatus (p2 in FIG. 29), when a DHCP (Dynamic Host Configuration Protocol) server is asked about server information [for example, IP (Internet Protocol) address or the like] of a REGISTER destination (p3 in FIG. 29), a malicious third party corrects server information of a server apparatus A (true) into server information of a dishonest server apparatus B (false) (p1 in FIG. 29), the DHCP server communicates the server information of the dishonest server apparatus (b) (false) to the client apparatus as the server information of the REGISTER destination (p4 in FIG. 29).

The client apparatus performs a REGISTER operation to the dishonest server apparatus B (false) on the basis of the server apparatus of the dishonest server apparatus B (false) (p5 to p8 in FIG. 29). At this time, when client authentication in the dishonest server apparatus (false) is achieved and completed (p9 in FIG. 29), a 200 response message (200 OK) is transmitted to the client apparatus (p10 in FIG. 29). For this reason, the client authentication is completed, and the client apparatus starts the operation under the dishonest server apparatus B (false) (p11 in FIG. 29). In this manner, according to the conventional art, spoofing by the dishonest server apparatus B (false) cannot be prevented.

In the present invention, a user name and a password for authentication between the server apparatus and the client apparatus are set in the server apparatus A (true) in advance (q1 in FIG. 30), and a server name, a user name, and a password for authentication between the client apparatus and the server apparatus A (true) are set in advance (q2 in FIG. 30). In this case, in the DHCP server, the malicious third party corrects the server information of the server apparatus A (true) into the server information of the dishonest server apparatus B (false) (q3 in FIG. 30). Even though the DHCP server transmits the server information of the dishonest server apparatus B (false) as server information of the REGISTER destination in response to inquiry from the client apparatus (q4 to q6 in FIG. 30), NG is set by server authentication by the client apparatus (q7 to q10 in FIG. 30).

Therefore, in the present invention, since the mutual authentication between the dishonest server apparatus B (false) and the client apparatus is not achieved, the client apparatus does not start an operation under the control of the dishonest server apparatus B (false) (q11 in FIG. 30). In this manner, in the present invention, the dishonest server apparatus B (false) can be prevented from being spoofed.

Although the exemplary embodiments of the present invention have been described in detail, it should be understood that various changes, substitutions and alternatives can be made therein without departing from the sprit and scope of the invention as defined by the appended claims. Further, it is the inventor's intent to retain all equivalents of the claimed invention even if the claims are amended during prosecution.

What is claimed is:

1. An SIP (Session Initiation Protocol)-protocol-coping client-server distributed system in which an SIP-protocol-coping client apparatus and an SIP-protocol-coping server apparatus are connected to a network, and client authentication to authenticate the client apparatus from the server apparatus when the client apparatus registers position information in the server apparatus,
means to authenticate the server apparatus from the client apparatus is arranged in each of the server apparatus and the client apparatus.

2. The client-server distributed system according to claim 1, wherein
the server apparatus includes means which sets and stores an externally input user name and an externally input password of the client apparatus and means which authenticates a user name and a password of a client apparatus to be connected by the client authentication, and
the client apparatus includes means which sets and stores an externally input server name of the server apparatus and the user name and the password of the client apparatus and means which authenticates a server name and a password of a server apparatus to be connected.

3. The client-server distributed system according to claim 2, wherein
the server apparatus is connected to a maintenance interface to which the user name and the password can be input, and
the client apparatus is connected to a maintenance interface to which the server name, the user name, and the password can be input.

4. The client-server distributed system according to claim 1, wherein
the client authentication and the server authentication are performed by challenge-digest authentication.

5. The client-server distributed system according to claim 4, wherein
the client apparatus includes means which generates a challenge to perform the server authentication to perform digest authentication, and
the server apparatus includes means which generates a digest on the basis of the challenge.

6. The client-server distributed system according to claims 1, wherein
in communication between the server apparatus and the client apparatus, authentication achievement is recognized when the client authentication and the client authentication are achieved.

7. The client-server distributed system according to claim 1, wherein
a one-time password is used in initial authentication between the server apparatus and the client apparatus.

8. The client-server distributed system according to claim 7, wherein
the one-time password is made invalid when authentication in communication between the server apparatus and the client apparatus is achieved.

9. The client-server distributed system according to claim 7, wherein
the server apparatus includes means which generates a mutual authentication password used in second and subsequent start-up states of the client apparatus and means which delivers the generated mutual authentication password to the client apparatus.

10. The client-server distributed system according to claim 7, wherein
the mutual authentication password is generated and set in initial authentication in the server apparatus, in a state in which the mutual authentication password is set in the client apparatus, the server apparatus performs authentication by using the user name of the client apparatus and the mutual authentication password in the second and subsequent start-up states of the client apparatus, and the client apparatus performs authentication by using the server name of the server apparatus and the mutual authentication password.

11. The client-server distributed system according to claim 7, wherein
the server apparatus encodes the mutual authentication password to deliver the mutual authentication password to the client apparatus, and
the client apparatus decodes and sets the encoded mutual authentication password.

12. The client-server distributed system according to claim 7, wherein
the server apparatus encodes the mutual authentication password in response to an external designation of the presence/absence of encoding to deliver the encoded mutual authentication password to the client apparatus and notifies the client apparatus of the designation of the presence/absence of encoding, and
the client apparatus sets the designation of the presence/absence of encoding transmitted from the server apparatus and decodes and sets the mutual authentication password in reception of the encoded mutual authentication password.

13. The client-server distributed system according to claim 7, wherein
the server apparatus sets an encoding rule externally designated and used in encoding of the mutual authentication password and transmits the encoding rule to the client apparatus, and
the client apparatus sets the encoding rule transmitted from the server apparatus.

14. The client-server distributed system according to claim 7, wherein
the server apparatus and the client apparatus generate and set an encoding key for delivery of the mutual authentication password by a common procedure.

15. The client-server distributed system according to claim 1, wherein
the server apparatus and the client apparatus repeat bidirectional authentication when communication between the server apparatus and the client apparatus is interrupted for a preset predetermined period of time.

16. The client-server distributed system according to claim 1, wherein
the server apparatus and the client apparatus repeat bidirectional authentication at preset intervals.

17. The client apparatus according to claim 1.

18. The server apparatus according to claim 1.

19. A mutual authentication method used in an SIP (Session Initiation Protocol)-protocol-coping client-server distributed system in which an SIP-protocol-coping client apparatus and an SIP-protocol-coping server apparatus are connected to a network, and client authentication to authenticate the client apparatus from the server apparatus when the client apparatus registers position information in the server apparatus, wherein
each of the server apparatus and the client apparatus execute a process to authenticate the server apparatus from the client apparatus.

20. The mutual authentication method according to claim 19, wherein
the server apparatus executes a process of setting and storing an externally input user name and an externally input password of the client apparatus and a process of authenticating a user name and a password of a client apparatus to be connected by the client authentication, and
the client apparatus executes a process of setting and storing an externally input server name of the server apparatus and the user name and the password of the client apparatus and a process of authenticating a server name and a password of a server apparatus to be connected.

21. The mutual authentication method according to claim 20, wherein
the server apparatus is connected to a maintenance interface to which the user name and the password can be input, and
the client apparatus is connected to a maintenance interface to which the server name, the user name, and the password can be input.

22. The mutual authentication method according to claim 19, wherein
the client authentication and the server authentication are performed by challenge-digest authentication.

23. The mutual authentication method according to claim 22, wherein
the client apparatus includes means which generates a challenge to perform the server authentication to perform digest authentication, and
the server apparatus includes means which generates a digest on the basis of the challenge.

24. The mutual authentication method according to claim 19, wherein
in communication between the server apparatus and the client apparatus, authentication achievement is recognized when the client authentication and the client authentication are achieved.

25. The mutual authentication method according to claim 19, wherein
a one-time password is used in initial authentication between the server apparatus and the client apparatus.

26. The mutual authentication method according to claim 25, wherein
the one-time password is made invalid when authentication in communication between the server apparatus and the client apparatus is achieved.

27. The mutual authentication method according to claim 25, wherein
the server apparatus includes means which generates a mutual authentication password used in second and subsequent start-up states of the client apparatus and means which delivers the generated mutual authentication password to the client apparatus.

28. The mutual authentication method according to claim 25, wherein
the mutual authentication password is generated and set in initial authentication in the server apparatus, in a state in which the mutual authentication password is set in the client apparatus, the server apparatus performs authentication by using the user name of the client apparatus and the mutual authentication password in the second and subsequent start-up states of the client apparatus, and the client apparatus performs authentication by using the server name of the server apparatus and the mutual authentication password.

29. The mutual authentication method according to claim 25, wherein
the server apparatus encodes the mutual authentication password to deliver the mutual authentication password to the client apparatus, and
the client apparatus decodes and sets the encoded mutual authentication password.

30. The mutual authentication method according to claim 25, wherein
the server apparatus encodes the mutual authentication password in response to an external designation of the presence/absence of encoding to deliver the encoded mutual authentication password to the client apparatus and notifies the client apparatus of the designation of the presence/absence of encoding, and
the client apparatus sets the designation of the presence/absence of encoding transmitted from the server apparatus and decodes and sets the mutual authentication password in reception of the encoded mutual authentication password.

31. The mutual authentication method according to claim 25, wherein
the server apparatus sets an encoding rule externally designated and used in encoding of the mutual authentication password and transmits the encoding rule to the client apparatus, and
the client apparatus sets the encoding rule transmitted from the server apparatus.

32. The mutual authentication method according to claims 25, wherein
the server apparatus and the client apparatus generate and set an encoding key for delivery of the mutual authentication password by a common procedure.

33. The mutual authentication method according to claim 19, wherein
the server apparatus and the client apparatus repeat bidirectional authentication when communication between the server apparatus and the client apparatus is interrupted for a preset predetermined period of time.

34. The mutual authentication method according to claim 19, wherein
the server apparatus and the client apparatus repeat bidirectional authentication at preset intervals.

35. A computer program product executed by a client apparatus in an SIP (Session Initiation Protocol)-protocol-coping client-server distributed system in which an SIP-protocol-coping client apparatus and an SIP-protocol-coping server apparatus are connected to a network, and client authentication to authenticate the client apparatus from the server apparatus when the client apparatus registers position information in the server apparatus, wherein
the computer program product causes a central processing device of the client apparatus to execute a process of setting and storing an externally input server name of the server apparatus and an externally input user name and an externally input password of the client apparatus and a process of authenticating a server name and a password of a server apparatus to be connected, and
the computer program product causes the client apparatus to authenticate the server apparatus.
